(19) United States
(12) Patent Application Publication
(10) Pub. No.: US 2017/0357388 A1
(43) Pub. Date: Dec. 14, 2017

(54) Device, Method, and Graphical User Interface for Managing Data Stored at a Storage Location

(71) Applicant: Apple Inc., Cupertino, CA (US)

(72) Inventors: Kazuhisa Yanagihara, Cupertino, CA (US); Kevin Charles Milden, Oxnard, CA (US); Steve Ko, Los Altos, CA (US); Jean-Pierre Ciudad, San Francisco, CA (US); Maxym Runov, Cupertino, CA (US); Robert Ulrich, San Jose, CA (US)

(21) Appl. No.: 15/609,549

(22) Filed: May 31, 2017

Related U.S. Application Data
(60) Provisional application No. 62/348,643, filed on Jun. 10, 2016.

(51) Int. Cl. G06F 3/0482; G06F 17/30

(52) U.S. Cl. CPC G06F 3/0482; G06F 17/30011; G06F 17/30017; G06F 17/30126

(57) ABSTRACT

In accordance with some embodiments, a method includes detecting a management input indicative of a request to manage data stored at the direction of the device at a storage location with a limited available storage capacity, and in response, displaying a data storage management user interface that includes a plurality of data storage management affordances. The method further includes, detecting selection of a particular data storage management affordance of the plurality of data storage management affordances; and, in response to detecting selection of the particular data storage management affordance, in accordance with a determination that the particular data storage management affordance is the first data storage management affordance, initiating a process for performing the first data storage management operation and, in accordance with a determination that the particular data storage management affordance is the second data storage management affordance, initiating a process for performing the second data storage management operation.

### CROSS-REFERENCE TO RELATED-APPLICATIONS

This application claims the benefit of U.S. Provisional Patent App. No. 62/348,643, filed on Jun. 10, 2016, which is incorporated by reference in its entirety.

### TECHNICAL FIELD

This relates generally to electronic devices with touch-sensitive surfaces, including but not limited to electronic devices with touch-sensitive surfaces that enable management of data stored at a storage location.

### BACKGROUND

The use of touch-sensitive surfaces as input devices for computers and other electronic computing devices has increased significantly in recent years. Example touch- sensitive surfaces include touchpads and touch-screen displays. Such surfaces are widely used to manipulate user interface objects on a display.

Example manipulations include adjusting the position and/or size of one or more user interface objects or activating buttons or opening files/applications represented by user interface objects, as well as associating metadata with one or more user interface objects or otherwise manipulating user interfaces. Example user interface objects include digital images, video, text, icons, control elements such as buttons and other graphics. A user will, in some circumstances, need to perform such manipulations on user interface objects in a file management program (e.g., Finder from Apple Inc. of Cupertino, Calif.), an image management application (e.g., Aperture, iPhoto, Photos from Apple Inc. of Cupertino, Calif.), a digital content (e.g., videos and music) management application (e.g., iTunes from Apple Inc. of Cupertino, Calif.), a drawing application, a presentation application (e.g., Keynote from Apple Inc. of Cupertino, Calif.), a word processing application (e.g., Pages from Apple Inc. of Cupertino, Calif.), a website creation application (e.g., iWeb from Apple Inc. of Cupertino, Calif.), a disk authoring application (e.g., iDVD from Apple Inc. of Cupertino, Calif.), or a spreadsheet application (e.g., Numbers from Apple Inc. of Cupertino, Calif.).

Some user interfaces can be manipulated to manage data stored at a storage location, such as deleting data from the storage location, compressing data at the storage location, or organizing data at the storage location. But methods for performing these manipulations are cumbersome and inefficient. For example, these methods take longer than necessary, thereby wasting energy, a consideration that is particularly important in battery-operated devices. In addition, these methods manage the data inefficiently, thereby wasting storage space at the storage location, a consideration that is particularly important for portable devices.

### SUMMARY

Accordingly, there is a need for electronic devices with faster, more efficient methods and interfaces for managing data stored at a storage location. Such methods and interfaces optionally complement or replace conventional methods for managing data stored at a storage location. Such methods and interfaces reduce the cognitive burden on a user and produce a more efficient human-machine interface. For battery-operated devices, such methods and interfaces conserve power and increase the time between battery charges.

The above deficiencies and other problems associated with user interfaces for electronic devices with touch-sensitive surfaces are reduced or eliminated by the disclosed devices. In some embodiments, the device is a desktop computer. In some embodiments, the device is portable (e.g., a notebook computer, tablet computer, or handheld device). In some embodiments, the device has a touchpad. In some embodiments, the device has a touch-sensitive display (also known as a “touch screen” or “touch-screen display”). In some embodiments, the device has a graphical user interface (GUI), one or more processors, memory and one or more modules, programs or sets of instructions stored in the memory for performing multiple functions. In some embodiments, the user interacts with the GUI primarily through stylus and/or finger contacts and gestures on the touch-sensitive surface. In some embodiments, the functions optionally include image editing, drawing, presenting, word processing, website creating, disk authoring, spreadsheet making, game playing, telephoning, video conferencing, e-mailing, instant messaging, workout support, digital photographing, digital videoing, web browsing, digital music playing, and/or digital video playing. Executable instructions for performing these functions are, optionally, included in a non-transitory computer readable storage medium or other computer program product configured for execution by one or more processors.

In accordance with some embodiments, a method is performed at a device with one or more processors, non-transitory memory, a display, and an input device. The method includes detecting, via the input device, a management input indicative of a request to manage data stored at the direction of the device at a storage location with a limited available storage capacity. In response to detecting the management input, the method includes displaying, on the display, a data storage management user interface that includes a plurality of data storage management affordances respectively associated with a plurality of data storage management operations. The plurality of data storage management affordances includes a first data storage management affordance that is associated with a first data storage management operation that is configured to be performed on data stored at the direction of the device at the storage location and is displayed concurrently with a description of the first data storage management operation and a second data storage management affordance that is associated with a second data storage management operation that is configured to be performed on data stored at the direction of the device at the storage location and is displayed concurrently with a description of the second data storage management operation. The method includes, while displaying the data storage management user interface, detecting, via the input device, selection of a particular data storage management affordance of the plurality of data storage management affordances. In response to detecting selection of the particular data storage management affordance, the method includes, in accordance with a determination that the particular data storage management affordance is the first data storage management affordance, initiating a process for performing the first data storage management operation and, in accordance with a determination that the particular data storage management affordance is the second data storage management affordance, initiating a process for performing the second data storage management operation.

In accordance with some embodiments, an electronic device includes a display unit configured to display a user interface, one or more input units configured to receive user inputs, a storage unit configured to store data, and a processing unit coupled with the display unit, the one or more input units, and the storage unit. The processing unit is configured to detect, via the one or more input units, a management input indicative of a request to manage data stored on the storage unit. The processing unit is configured to, in response to detecting the management input, display, on the display unit, a data storage management user interface that includes a plurality of data storage management affordances respectively associated with a plurality of data storage management operations. The plurality of data storage management affordances includes a first data storage management affordance that is associated with a first data storage management operation that is configured to be performed on data stored on the storage unit and is displayed concurrently with a description of the first data storage management operation and a second data storage management affordance that is associated with a second data storage management operation that is configured to be performed on data stored on the storage unit and is displayed concurrently with a description of the second data storage management operation. The processing unit is configured to, while displaying the data storage management user interface, detect, via the one or more input units, selection of a particular data storage management affordance of the plurality of data storage management affordances. In response to detecting selection of the particular data storage management affordance, the processing unit is configured to, in accordance with a determination that the particular data storage management affordance is the first data storage management affordance, initiate a process for performing the first data storage management operation and, in accordance with a determination that the particular data storage management affordance is the second data storage management affordance, initiate a process for performing the second data storage management operation.

In accordance with some embodiments, an electronic device includes a display, an input device, one or more processors, non-transitory memory, and one or more programs; the one or more programs are stored in the non-transitory memory and configured to be executed by the one or more processors and the one or more programs include instructions for performing or causing performance of the operations of any of the methods described herein. In accordance with some embodiments, a non-transitory computer readable storage medium has stored therein instructions which when executed by one or more processors of an electronic device with a display and an input device, cause the device to perform or cause performance of the operations of any of the methods described herein. In accordance with some embodiments, a graphical user interface on an electronic device with a display, an input device, a memory, and one or more processors to execute one or more programs stored in the non-transitory memory includes one or more of the elements displayed in any of the methods described above, which are updated in response to inputs, as described in any of the methods described herein. In accordance with some embodiments, an electronic device includes: a display, an input device; and means for performing or causing performance of the operations of any of the methods described herein. In accordance with some embodiments, an information processing apparatus, for use in an electronic device with a display and an input device, includes means for performing or causing performance of the operations of any of the methods described herein.

Thus, electronic devices with displays, touch-sensitive surfaces and optionally one or more sensors to detect intensity of contacts with the touch-sensitive surface are provided with faster, more efficient methods and interfaces for managing data stored at a storage location, thereby increasing the effectiveness, efficiency, and user satisfaction with such devices. Such methods and interfaces may complement or replace conventional methods for managing data stored at a storage location.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating example components for event handling in accordance with some embodiments.

FIG. 2 illustrates a portable multifunction device having a touch screen in accordance with some embodiments.

FIG. 3 is a block diagram of an example multifunction device with a display and a touch-sensitive surface in accordance with some embodiments.

FIG. 4A illustrates an example user interface for a menu of applications on a portable multifunction device in accordance with some embodiments.

FIG. 4B illustrates an example user interface for a multifunction device with a touch-sensitive surface that is separate from the display in accordance with some embodiments.

FIGS. 5A-5P illustrate example user interfaces for managing data stored at a storage location in accordance with some embodiments.

FIGS. 6A-6E are flow diagrams illustrating a method of managing data stored at a storage location in accordance with some embodiments.

FIG. 7 is a functional block diagram of an electronic device in accordance with some embodiments.

### DESCRIPTION OF EMBODIMENTS

Many electronic devices store data at a storage location with a limited available storage capacity. The storage location may be an internal storage location (e.g., an internal hard drive of the electronic device) or an external storage location (e.g., an external hard drive of the electronic device, an internal hard drive of a coupled electronic device, like a smartwatch, or a cloud storage account). Because the storage location has a limited available storage capacity, a user may desire to delete (or compress) data at the storage location in order to store other data at the storage location. Accordingly, in embodiments described below, a data storage management user interface is presented to allow a user to efficiently manage storage at the storage location.

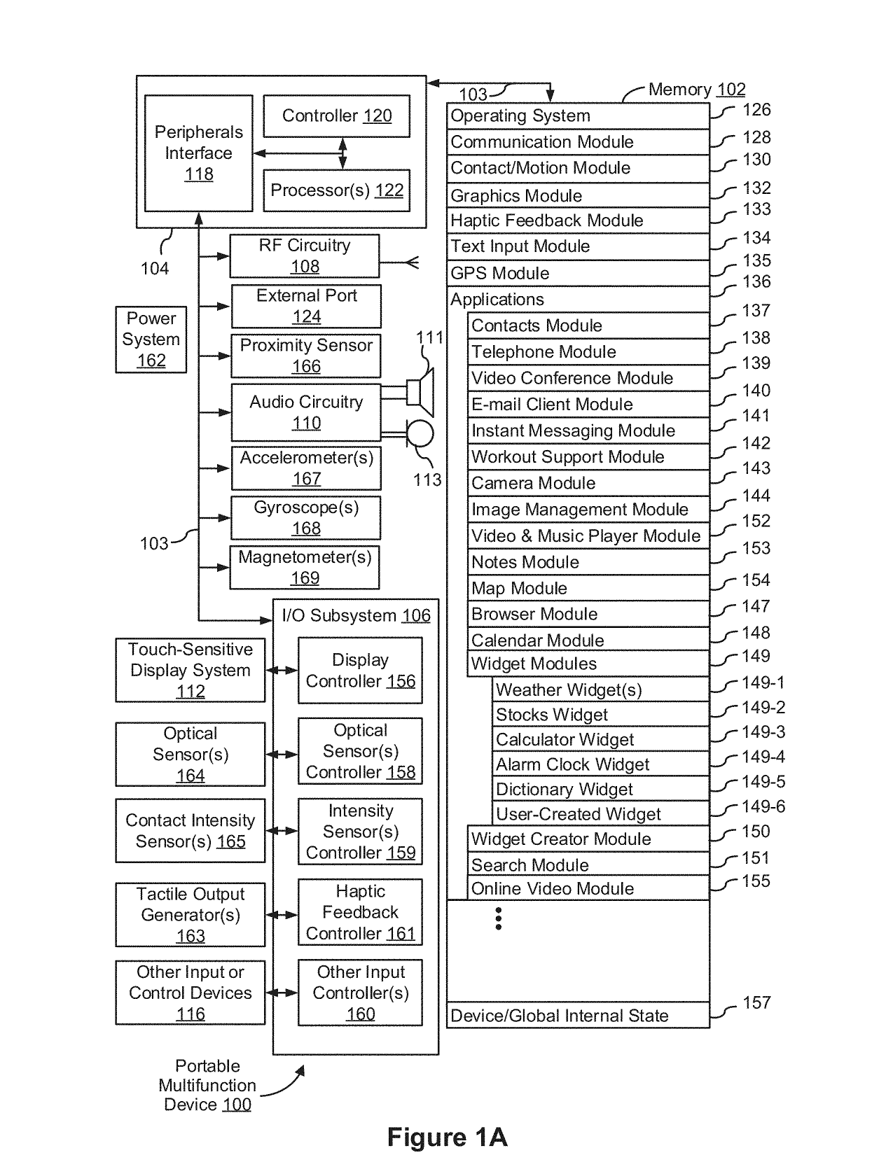

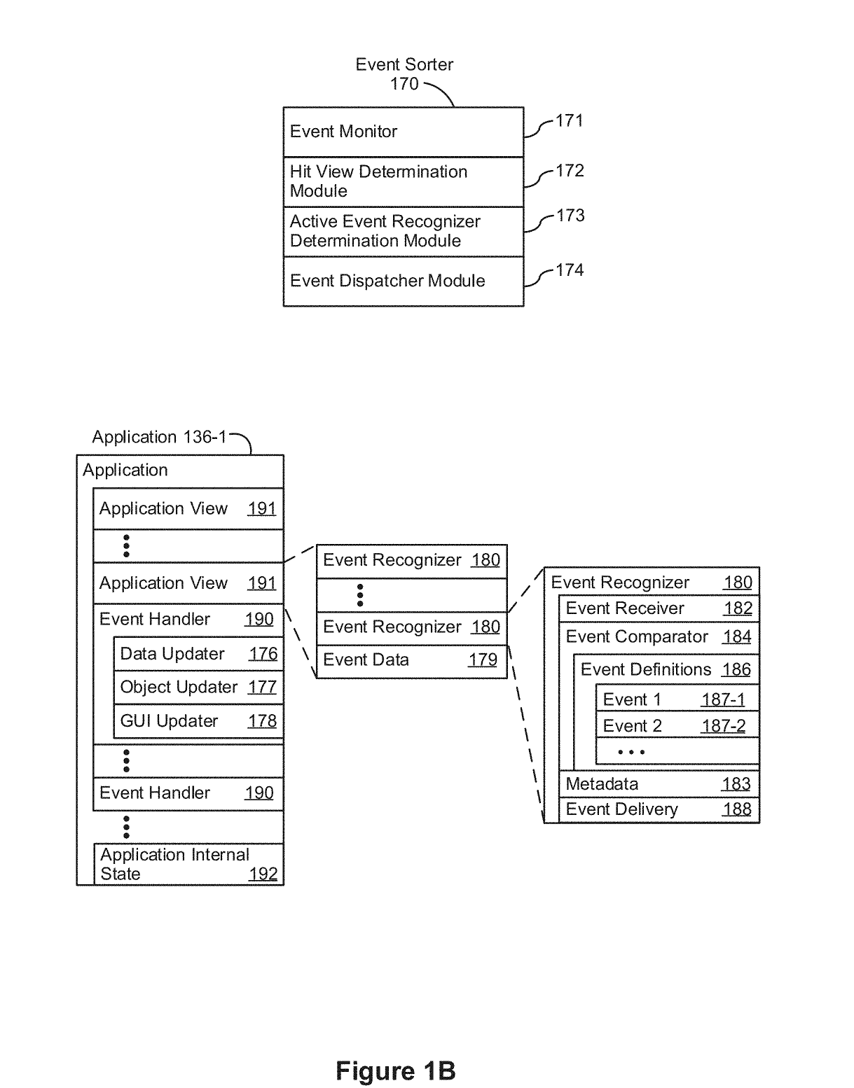

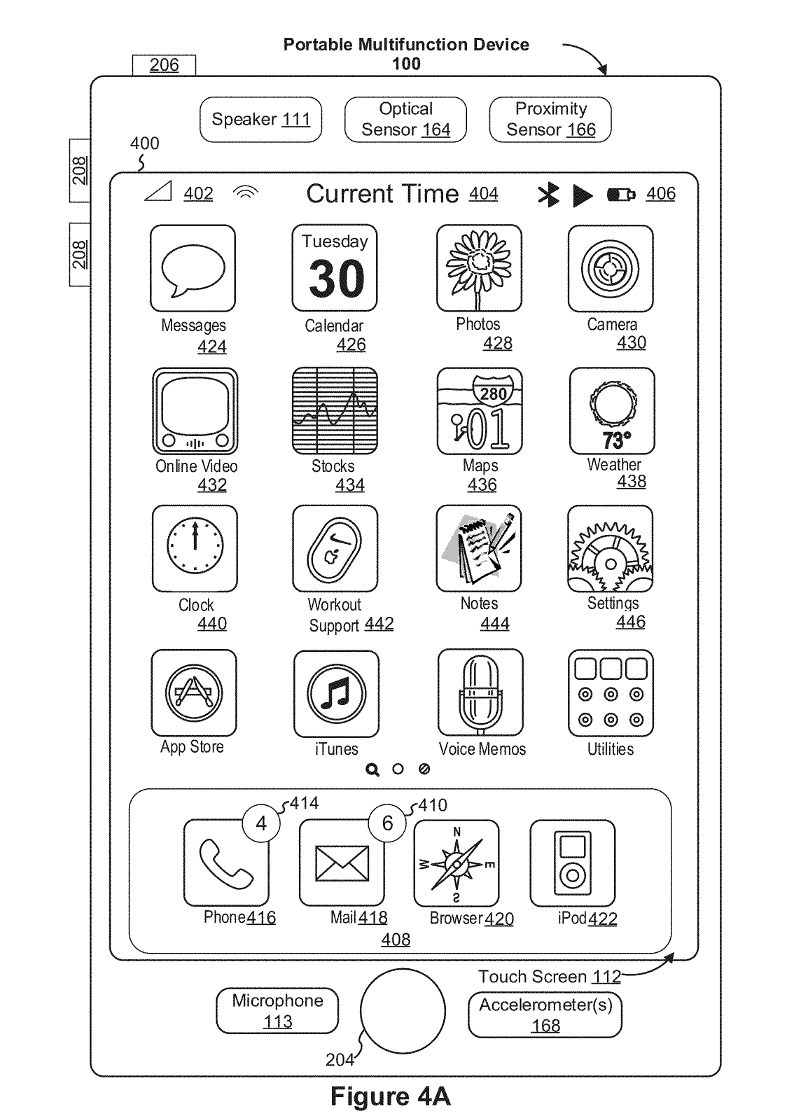

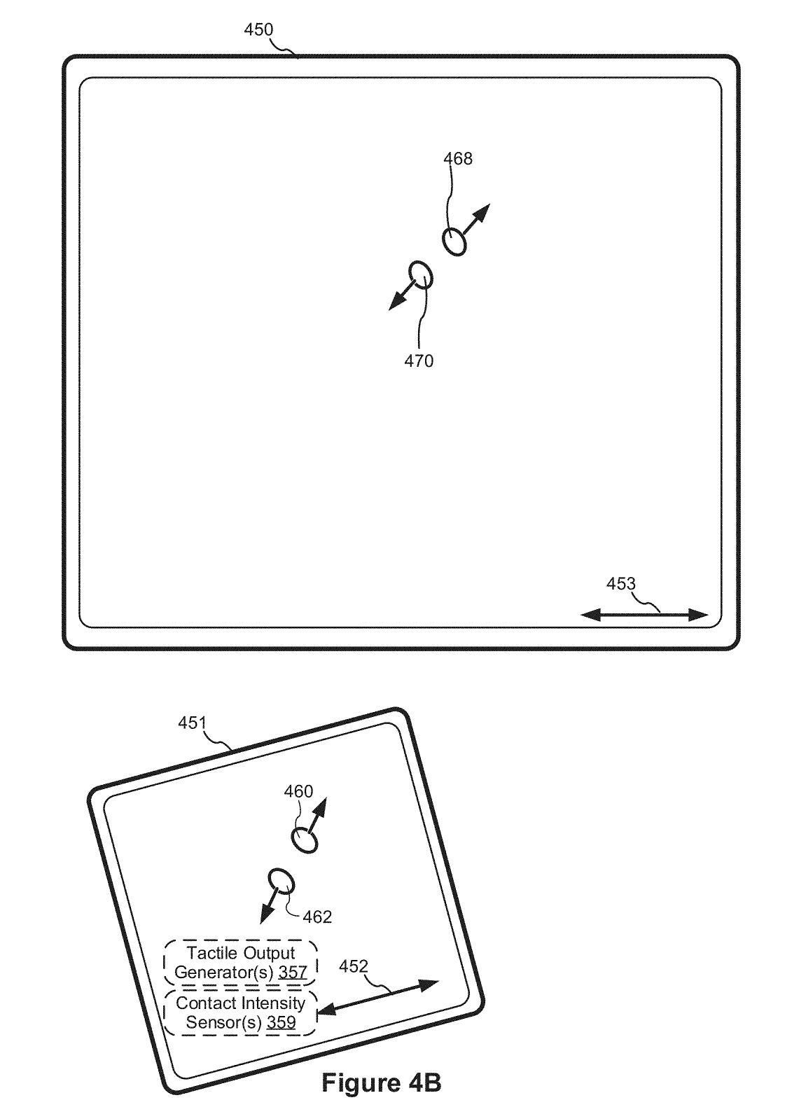

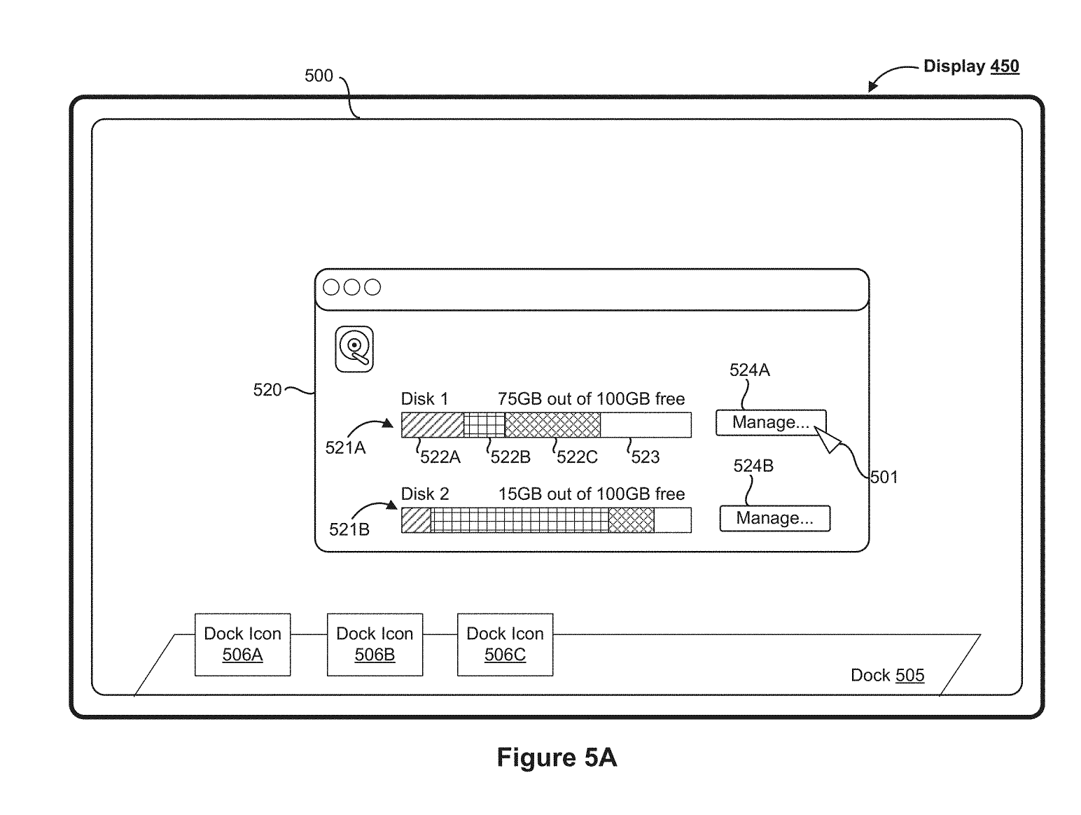

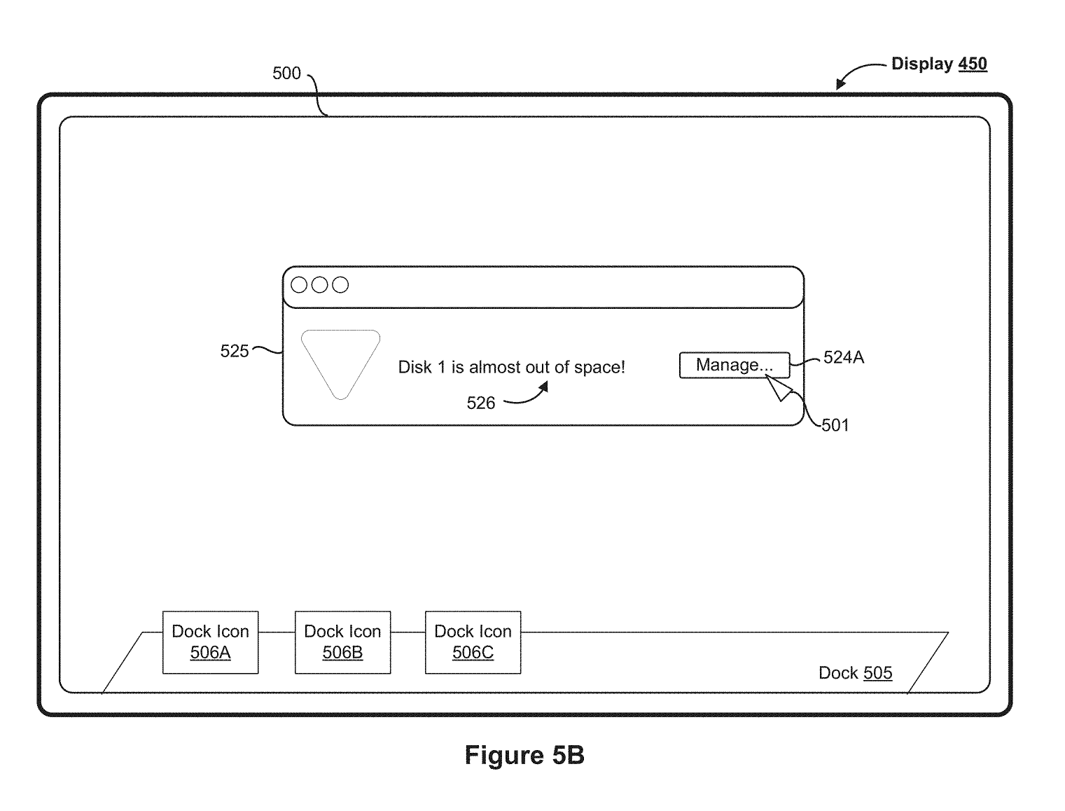

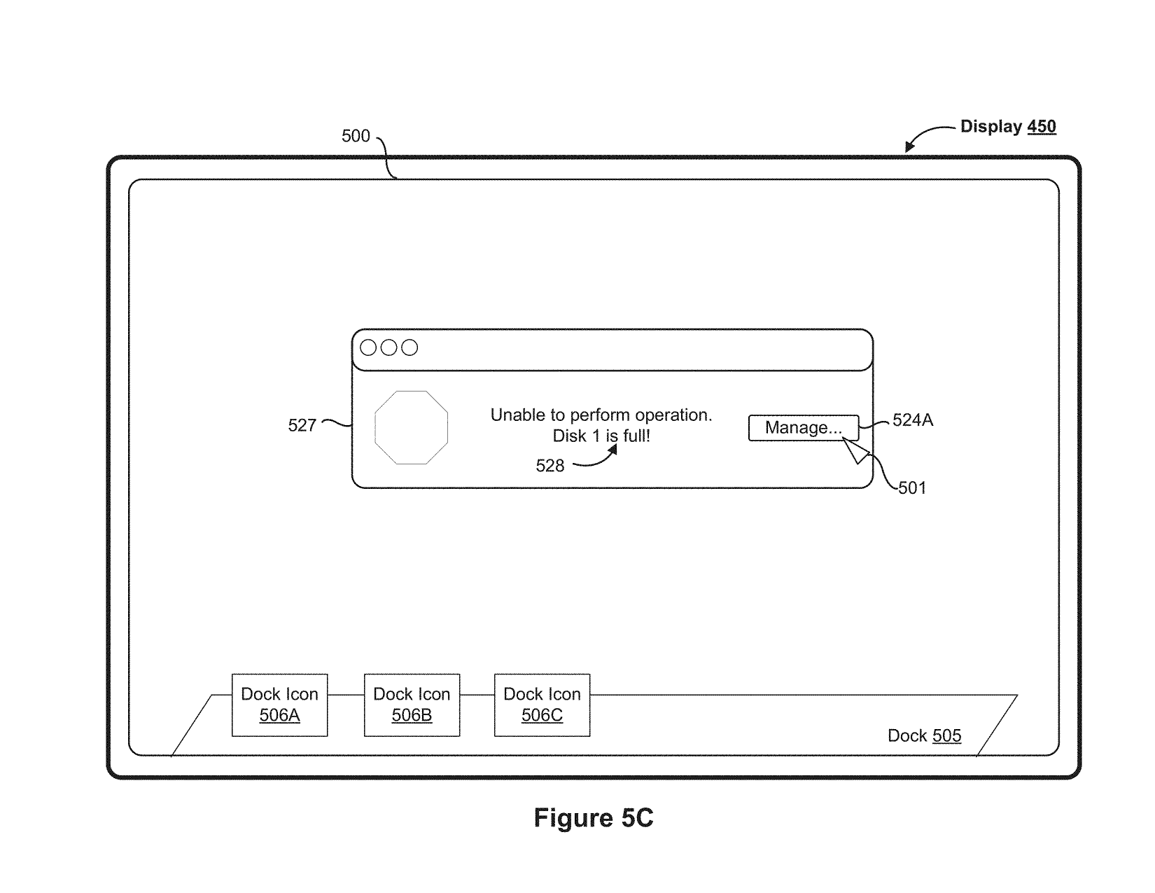

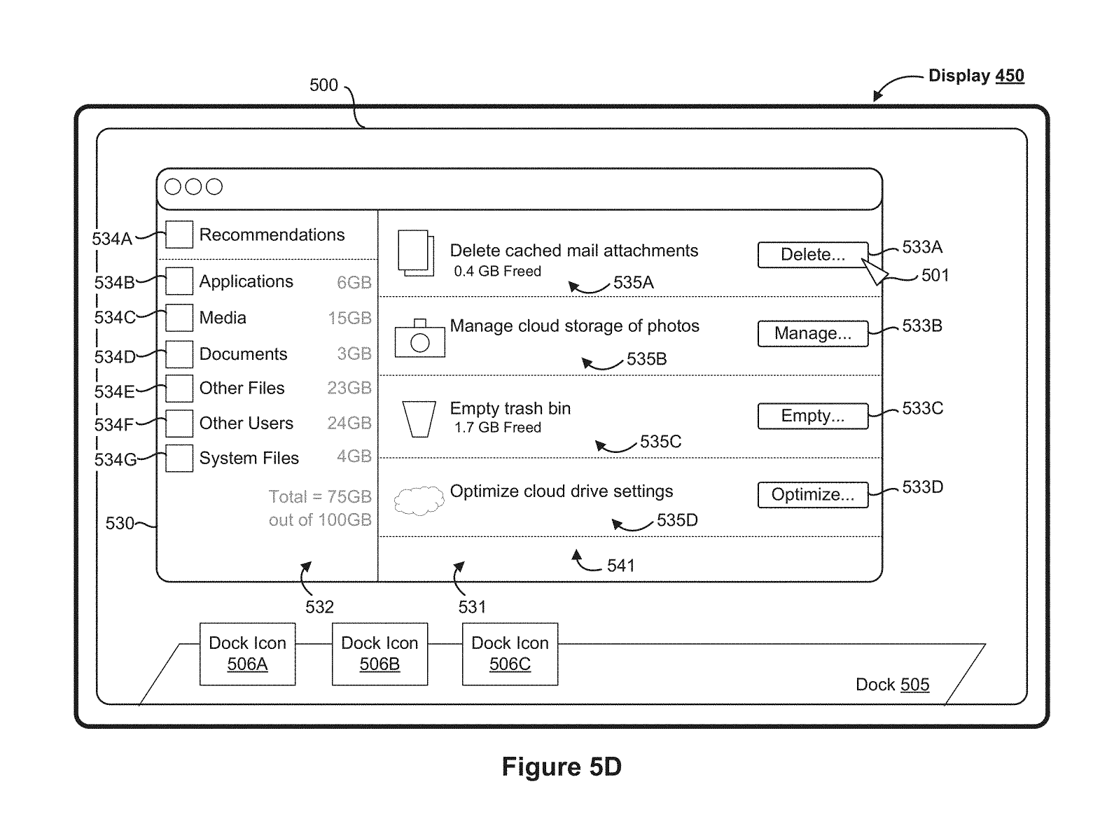

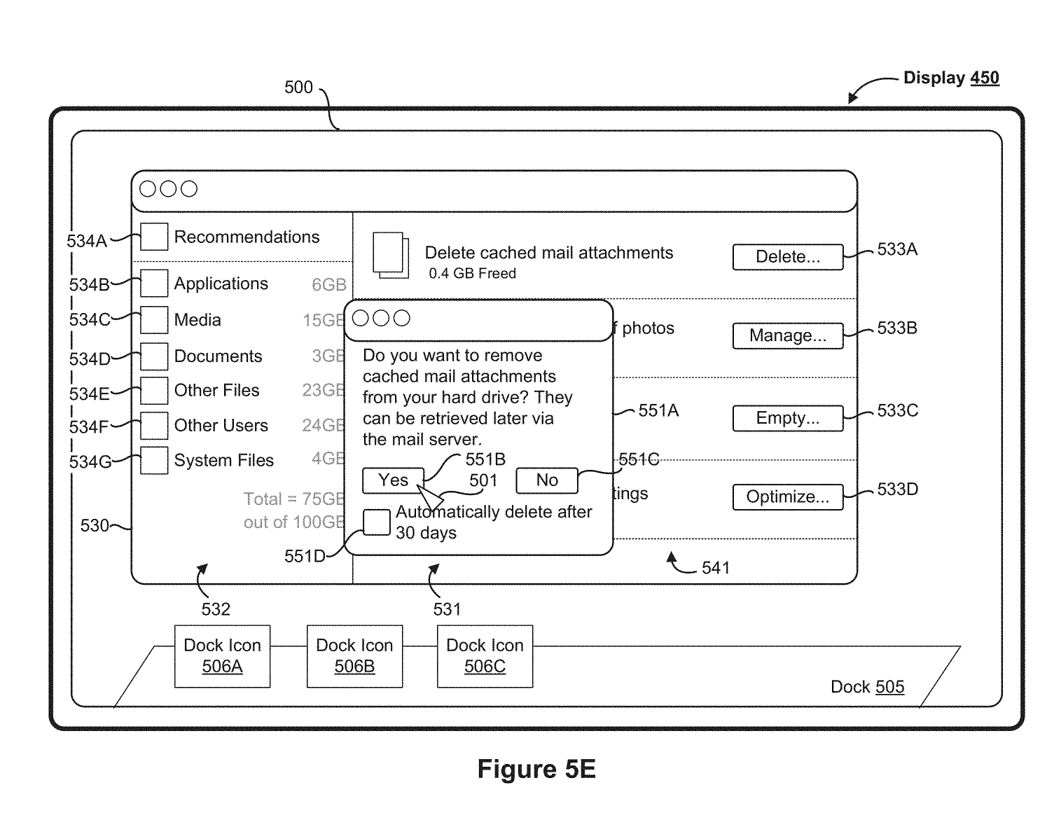

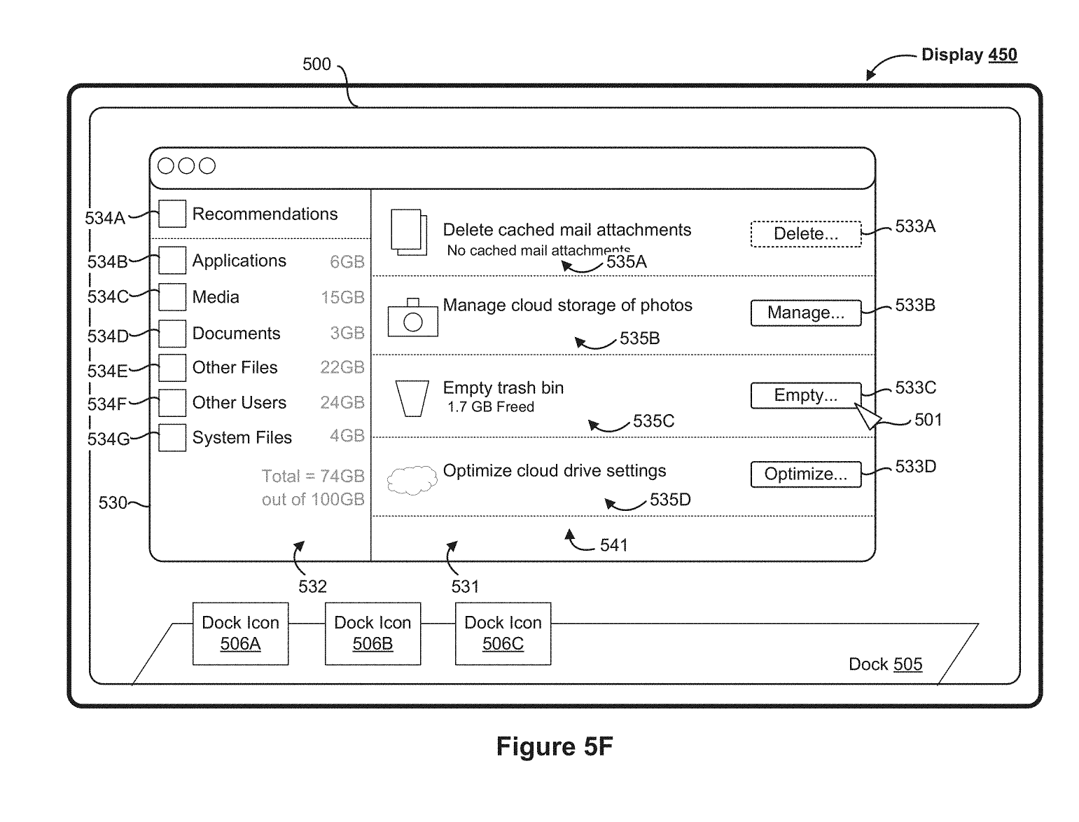

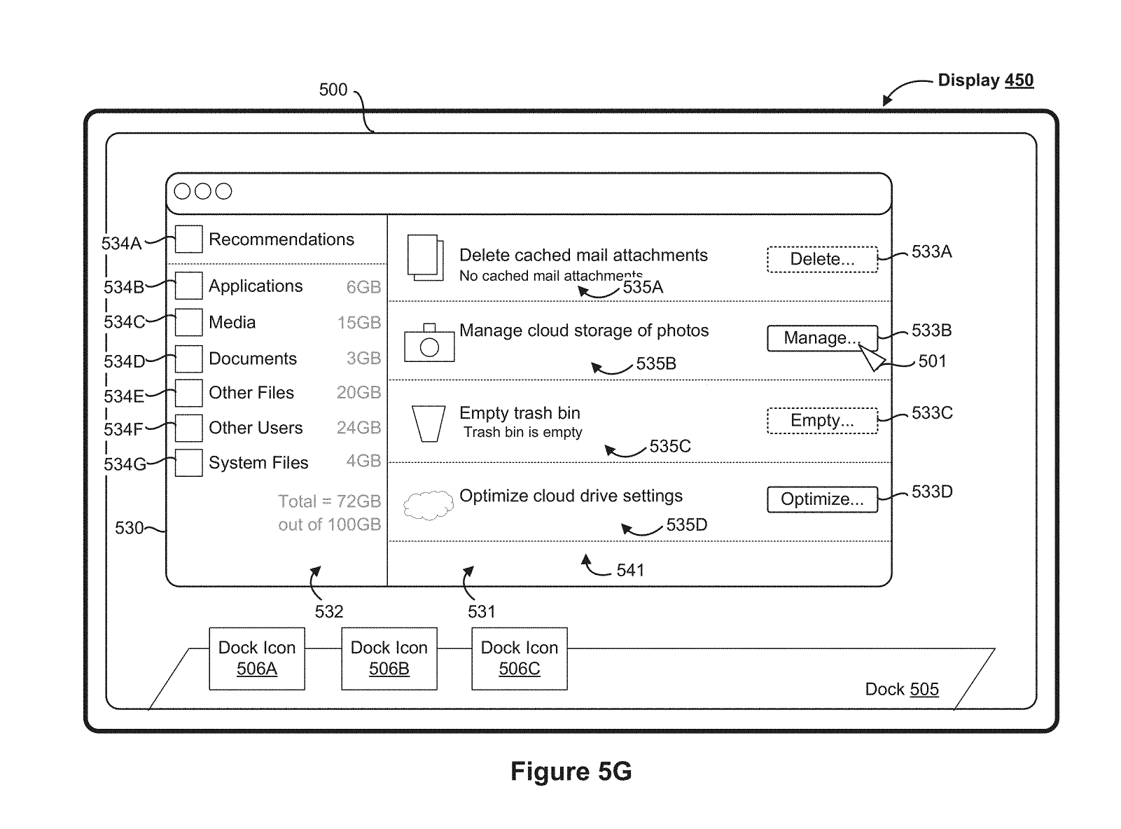

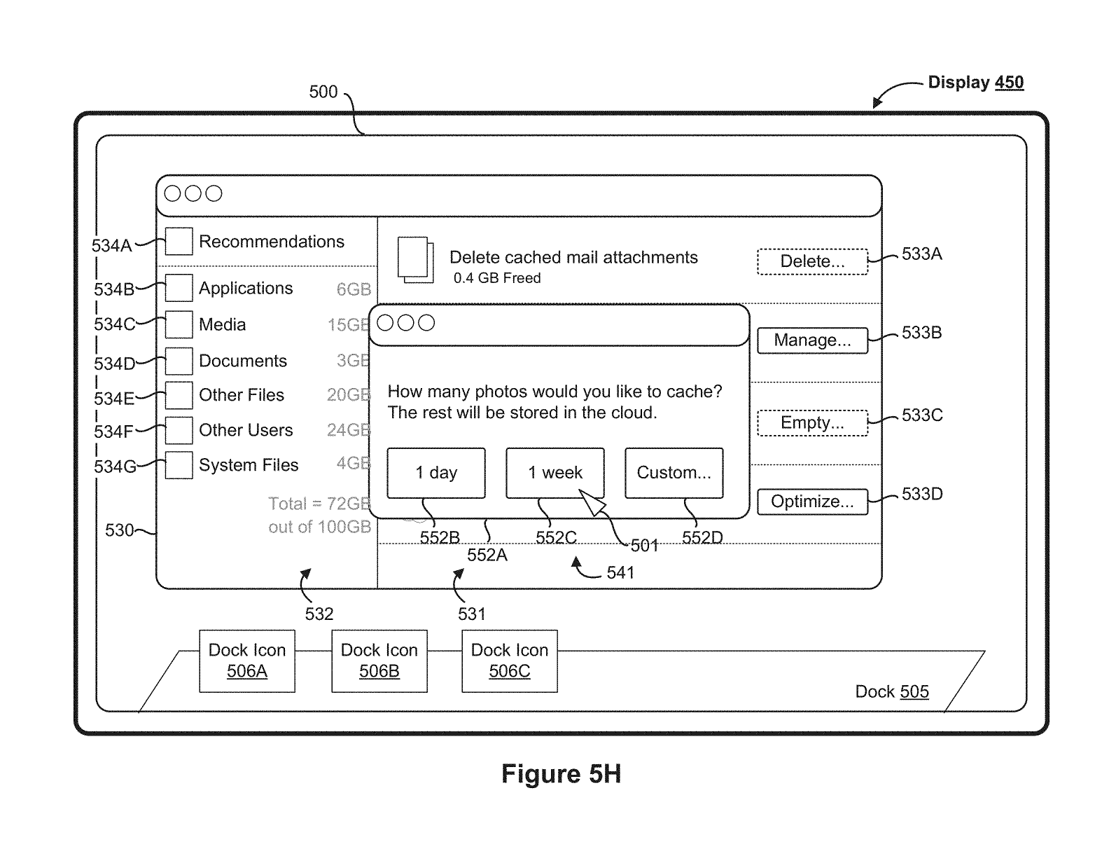

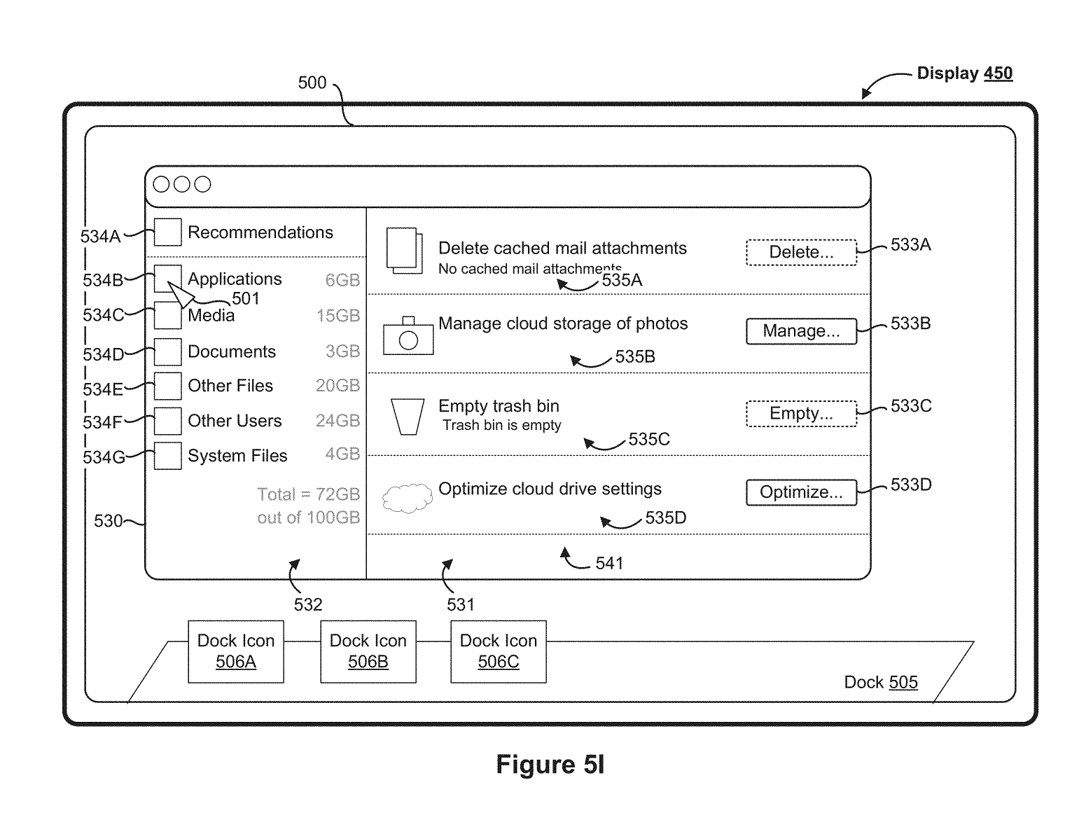

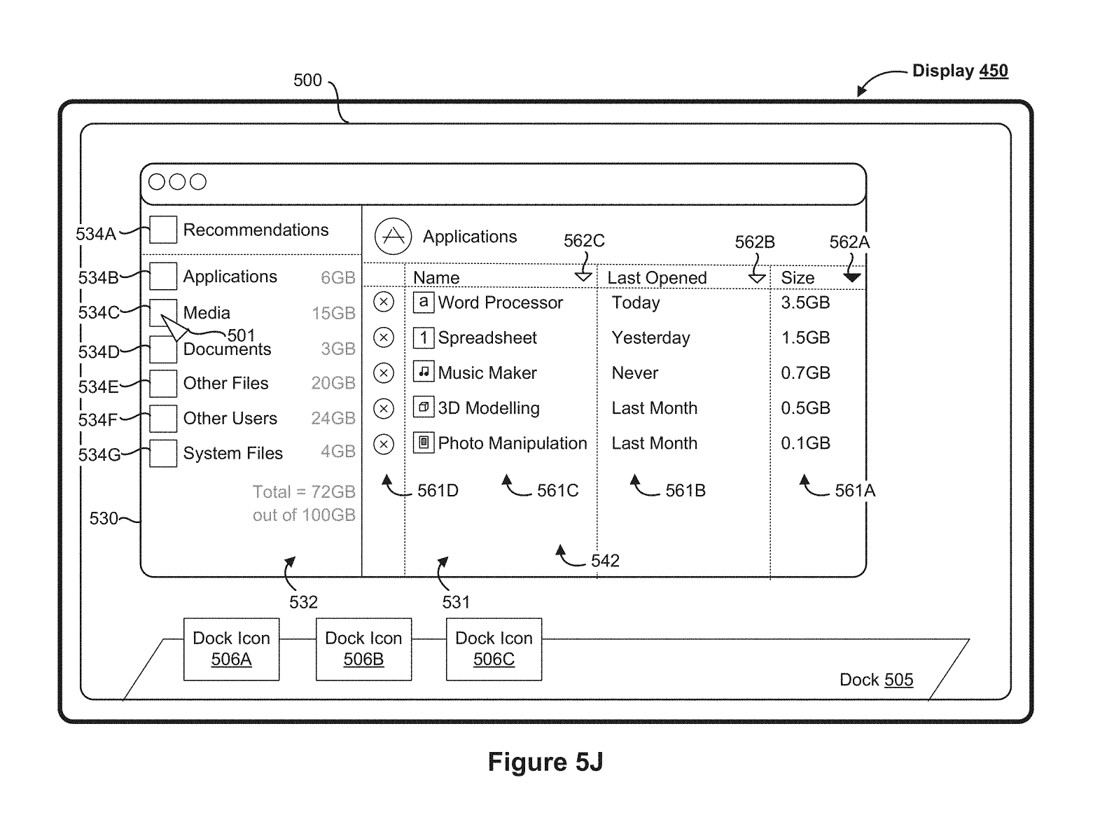

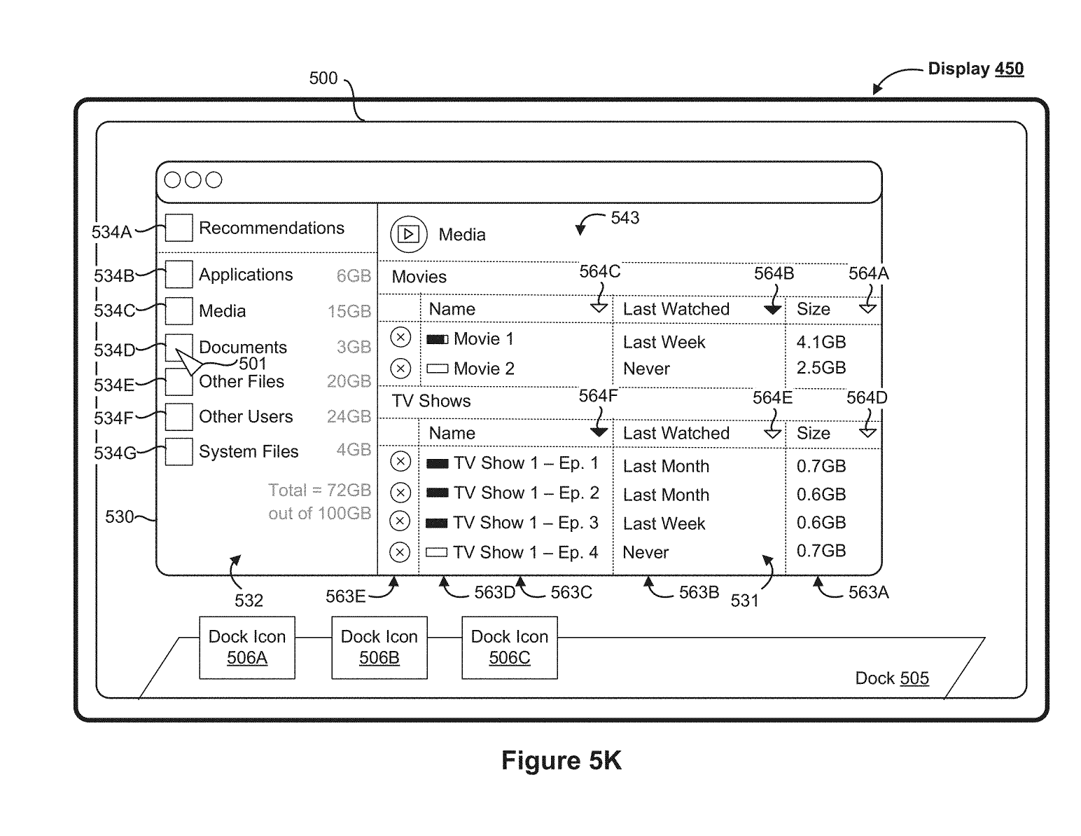

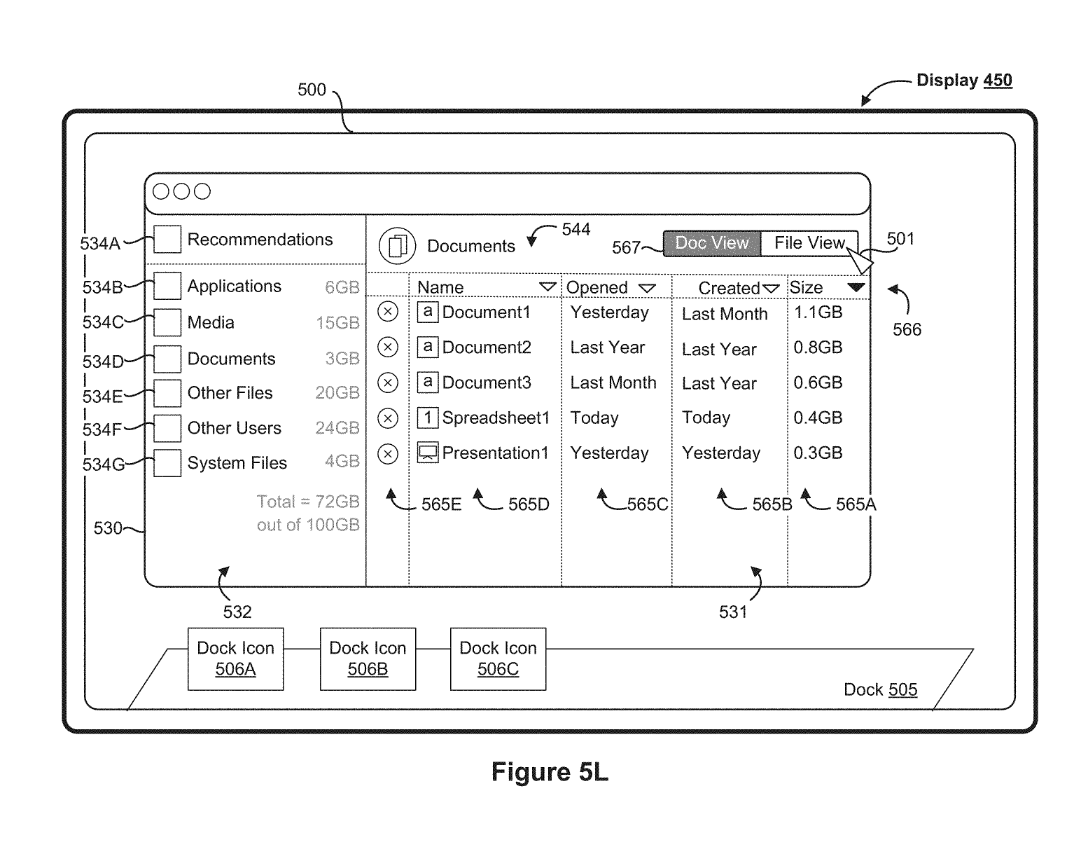

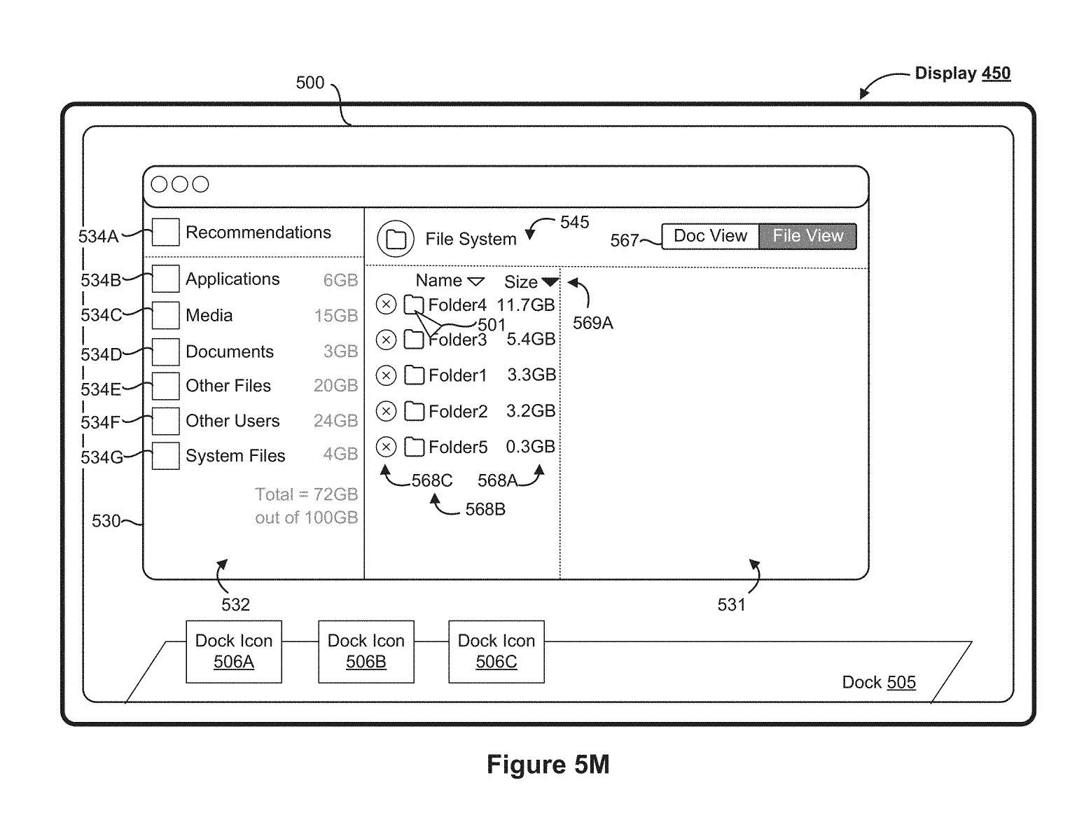

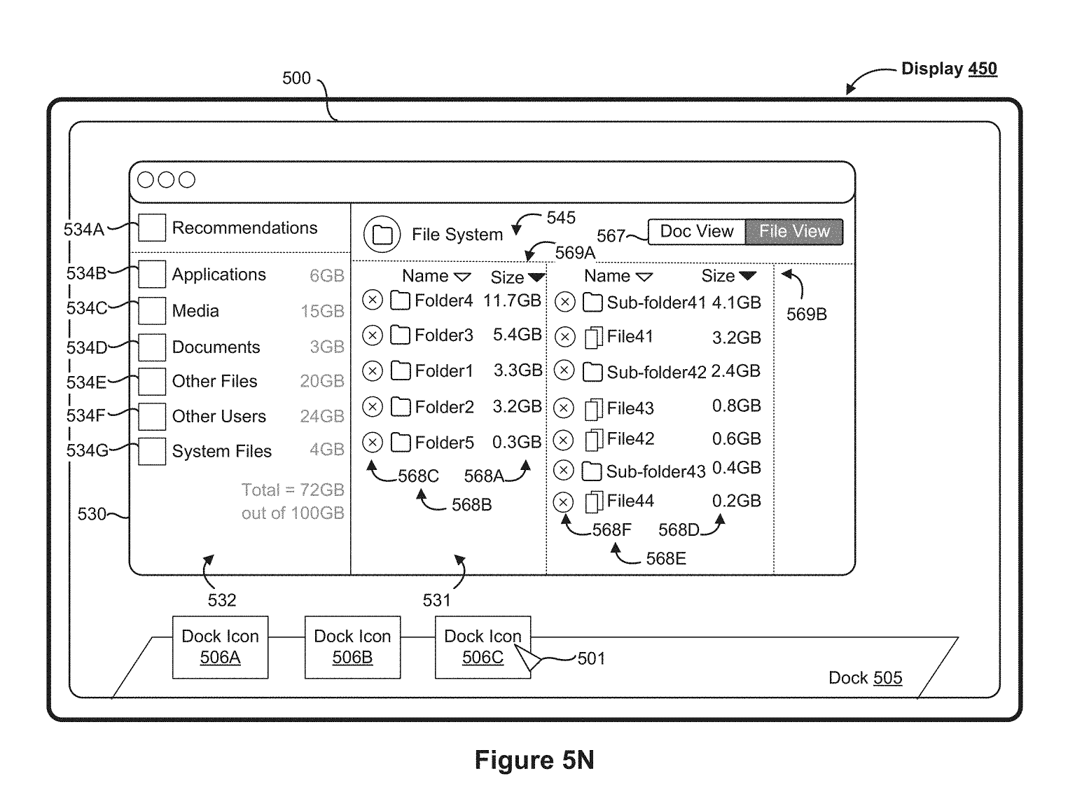

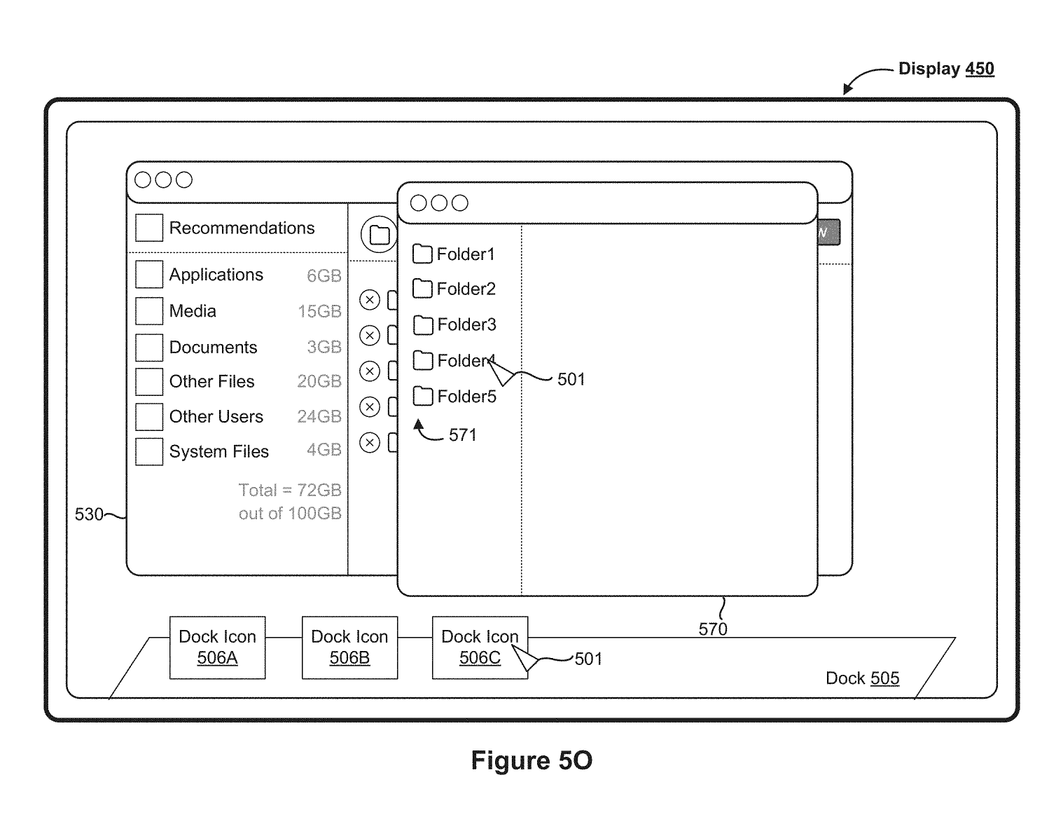

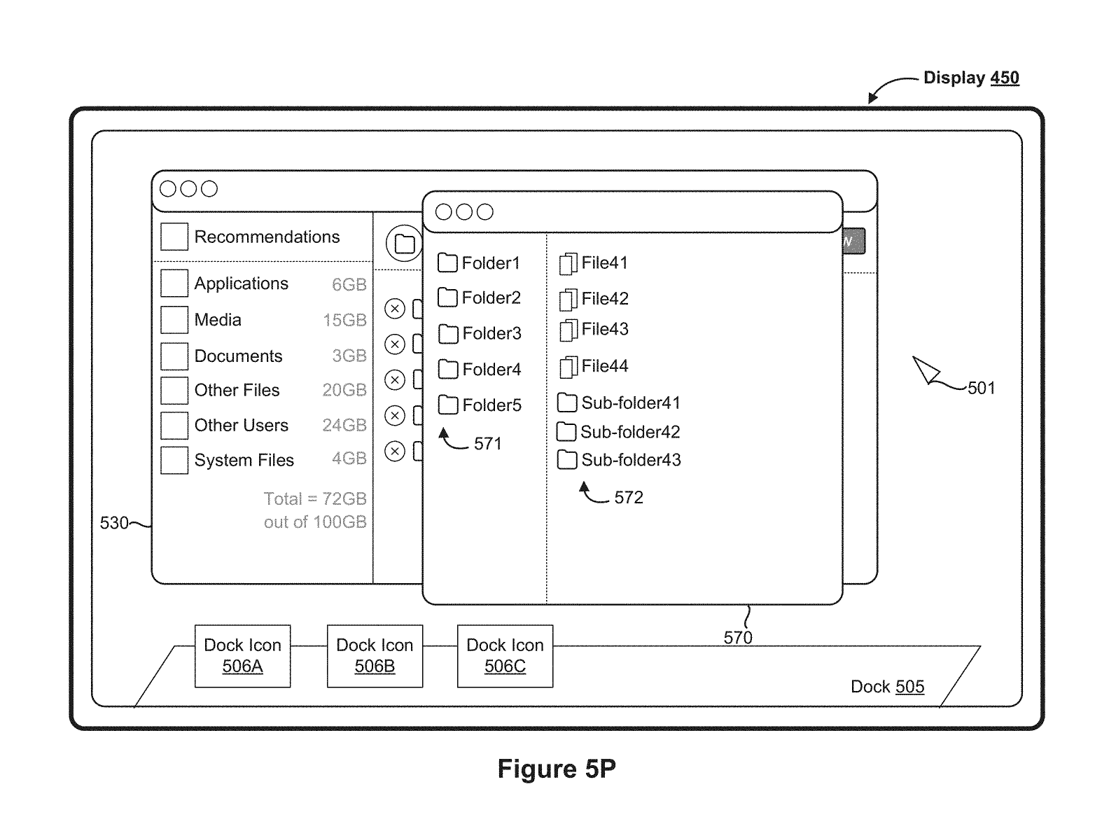

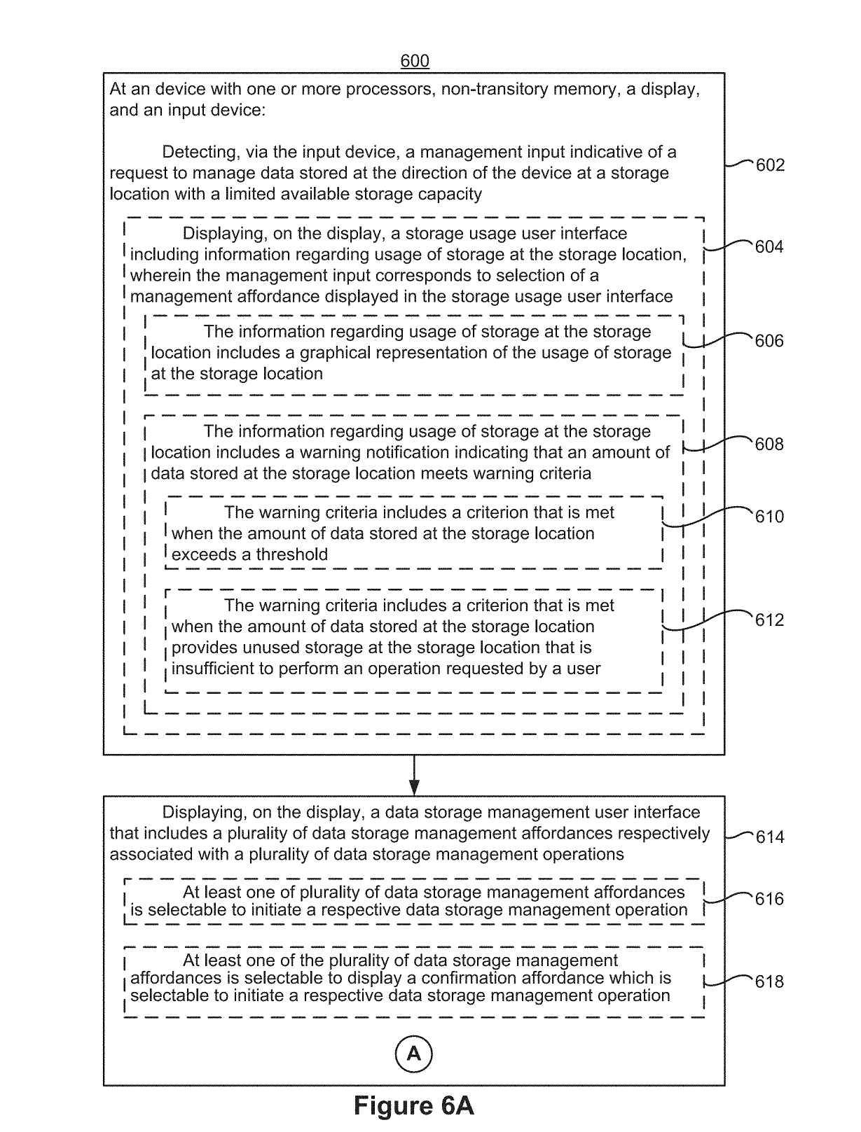

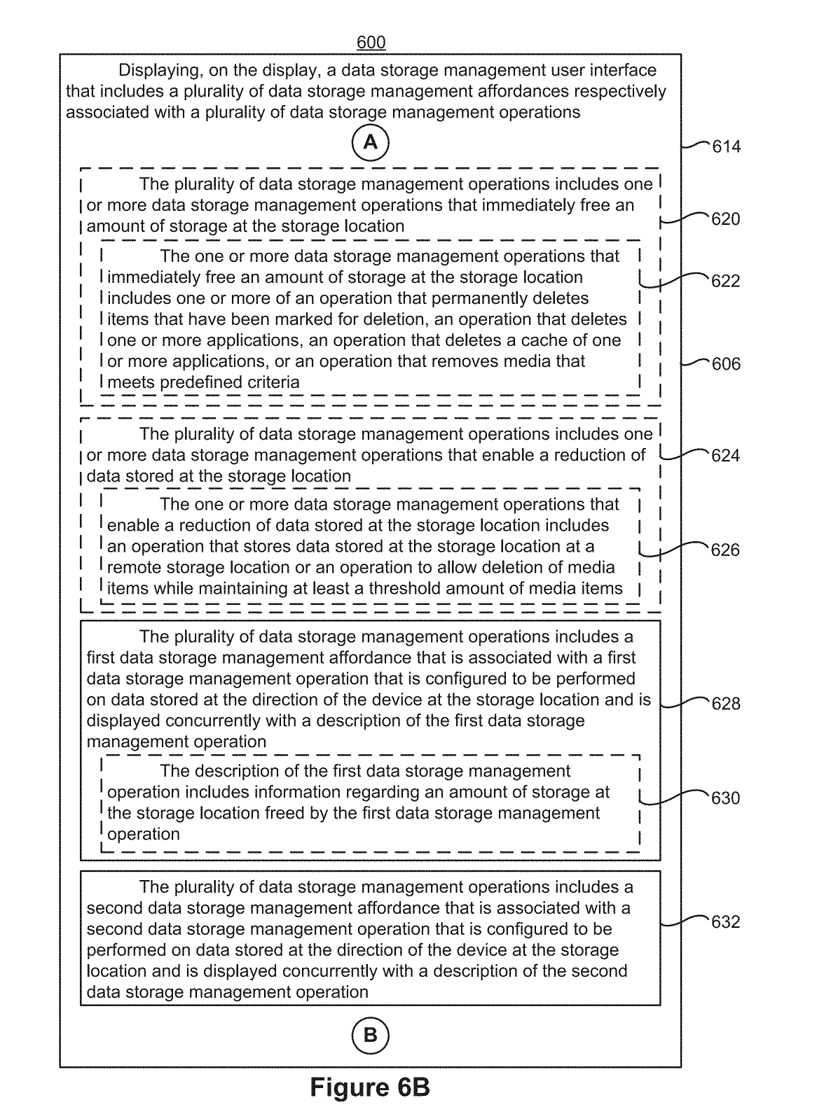

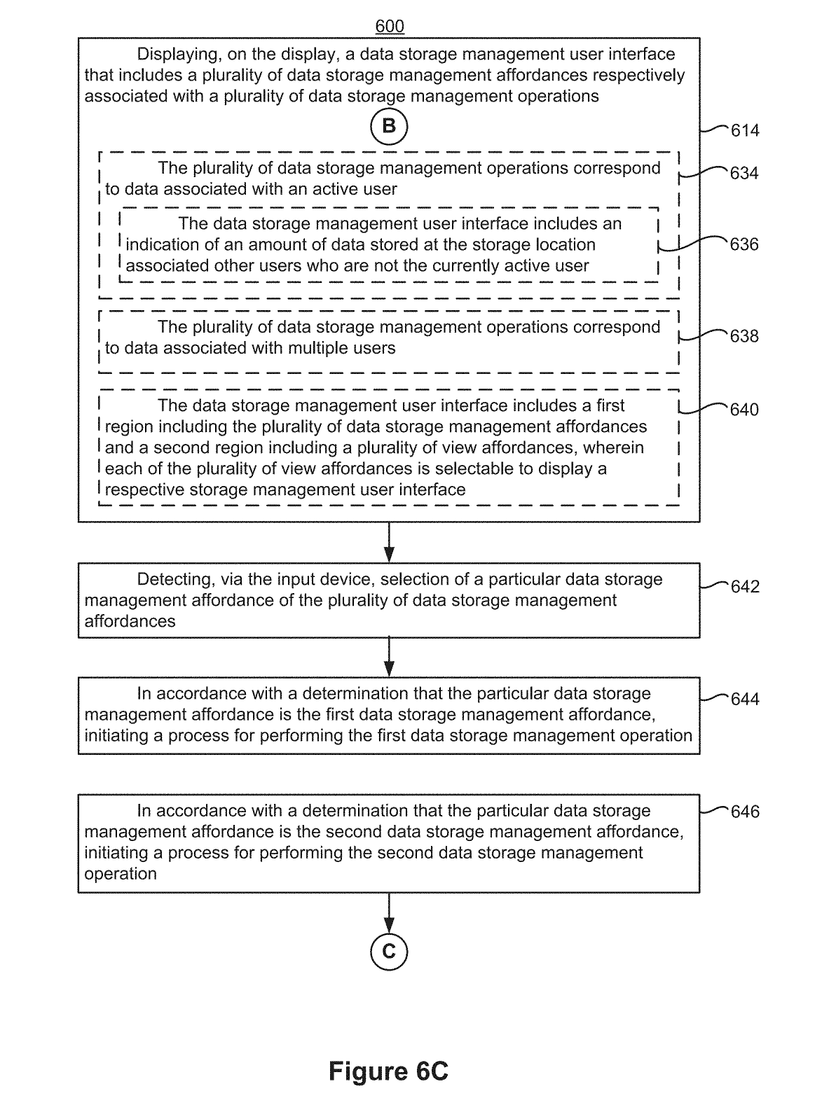

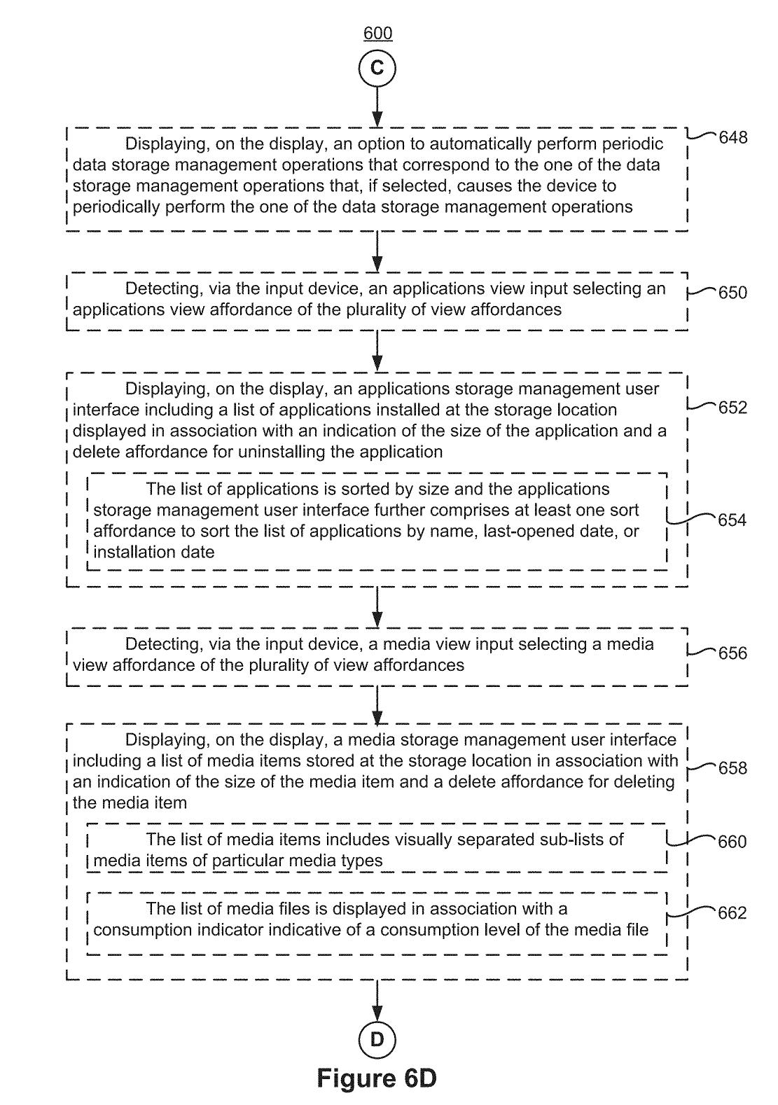

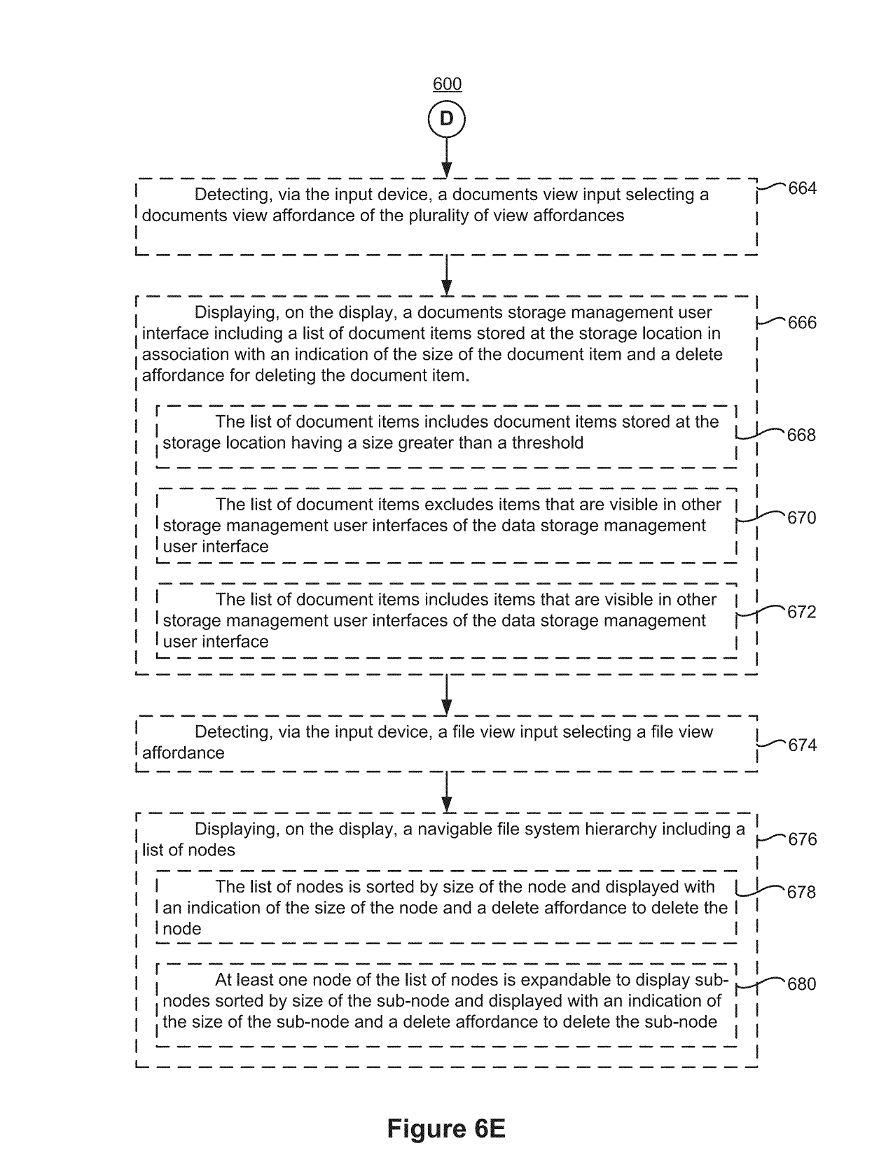

Below, FIGS. 1A-1B, 2, and 3 provide a description of example devices. FIGS. 4A-4B and 5A-5P illustrate example user interfaces for managing data stored at a storage location. FIGS. 6A-6E illustrate a flow diagram of a method of managing data stored at a storage location. The user interfaces in FIGS. 5A-5P are used to illustrate the processes in FIGS. 6A-6E.

### EXAMPLE DEVICES

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact, unless the context clearly indicates otherwise.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices, user interfaces for such devices, and associated processes for using such devices are described. In some embodiments, the device is a portable communications device, such as a mobile telephone, that also contains other functions, such as PDA and/or music player functions. Example embodiments of portable multifunction devices include, without limitation, the iPhone®, iPod Touch®, and iPad® devices from Apple Inc. of Cupertino, Calif. Other portable electronic devices, such as laptops or tablet computers with touch-sensitive surfaces (e.g., touch-screen displays and/or touchpads), are, optionally, used. It should also be understood that, in some embodiments, the device is not a portable communications device, but is a desktop computer with a touch-sensitive surface (e.g., a touch-screen display and/or a touchpad).

In the discussion that follows, an electronic device that includes a display and a touch-sensitive surface is described. It should be understood, however, that the electronic device optionally includes one or more other physical user-interface devices, such as a physical keyboard, a mouse and/or a joystick.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

Attention is now directed toward embodiments of portable devices with touch-sensitive displays. FIG. 1A is a block diagram illustrating portable multifunction device 100 with touch-sensitive display system 112 in accordance with some embodiments. Touch-sensitive display system 112 is sometimes called a “touch screen” for convenience, and is sometimes simply called a touch-sensitive display. Device 100 includes memory 102 (which optionally includes one or more computer readable storage mediums), memory controller 122, one or more processing units (CPUs) 120, peripherals interface 118, RF circuitry 108, audio circuitry 110, speaker 111, microphone 113, input/output (I/O) subsystem 106, other input or control devices 116, and external port 124. Device 100 optionally includes one or more optical sensors 164. Device 100 optionally includes one or more intensity sensors 165 for detecting intensity of contacts on device 100 (e.g., a touch-sensitive surface such as touch-sensitive display system 112 of device 100). Device 100 optionally includes one or more tactile output generators 163 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, firmware, or a combination thereof, including one or more signal processing and/or application specific integrated circuits.

Memory 102 optionally includes high-speed random access memory and optionally also includes non-volatile memory, such as one or more magnetic disk storage devices, flash memory devices, or other non-volatile solid-state memory devices. Access to memory 102 by other components of device 100, such as CPU(s) 120 and the peripherals interface 118, is, optionally, controlled by memory controller 122.

Peripherals interface 118 can be used to couple input and output peripherals of the device to CPU(s) 120 and memory 102. The one or more processors 120 run or execute various software programs and/or sets of instructions stored in memory 102 to perform various functions for device 100 and to process data.

In some embodiments, peripherals interface 118, CPU(s) 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The wireless communication optionally uses any of a plurality of communications standards, protocols and technologies, including but not limited to Global System for Mobile Communications (GSM), Enhanced Data GSM Environment (EDGE), high-speed downlink packet access (HSDPA), high-speed uplink packet access (HSDPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11ac, IEEE 802.11ax, IEEE 802.11b, IEEE 802.11g and/or IEEE 802.11n), voice over Internet Protocol (VoW), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

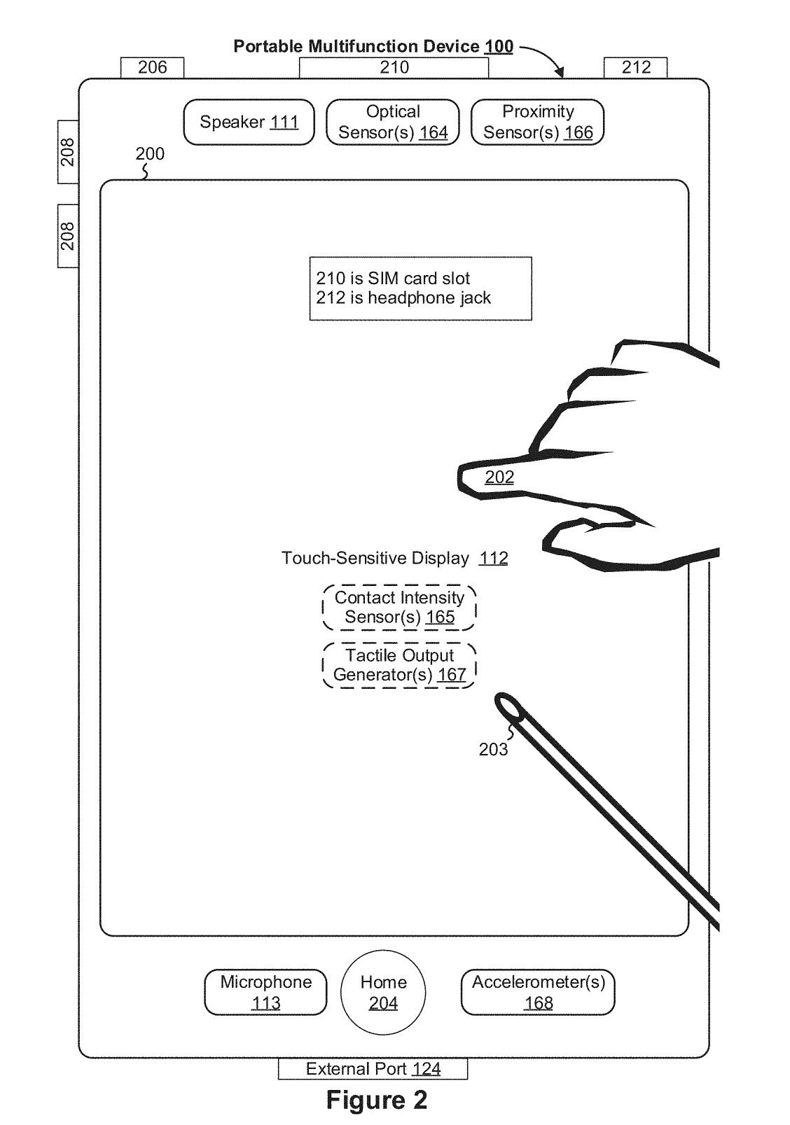

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both ears) and input (e.g., a microphone).

I/O subsystem 106 couples input/output peripherals on device 100, such as touch-sensitive display system 112 and other input or control devices 116, with peripherals interface 118. I/O subsystem 106 optionally includes display controller 156, optical sensor controller 158, intensity sensor controller 159, haptic feedback controller 161, and one or more input controllers 160 for other input or control devices. The one or more input controllers 160 receive/send electrical signals from/to other input or control devices 116. The other input or control devices 116 optionally include physical buttons (e.g., push buttons, rocker buttons, etc.), dials, slider switches, joysticks, click wheels, and so forth. In some alternate embodiments, input controller(s) 160 are, optionally, coupled with any (or none) of the following: a keyboard, infrared port, USB port, stylus, and/or a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2).

Touch-sensitive display system 112 provides an input interface and an output interface between the device and a user. Display controller 156 receives and/or sends electrical signals from/to touch-sensitive display system 112. Touch-sensitive display system 112 displays visual output to the user. The visual output optionally includes graphics, text, icons, video, and any combination thereof (collectively termed “graphics”). In some embodiments, some or all of the visual output corresponds to user-interface objects.

Touch-sensitive display system 112 has a touch-sensitive surface, sensor or set of sensors that accepts input from the user based on haptic/tactile contact. Touch-sensitive display system 112 and display controller 156 (along with any associated modules and/or sets of instructions in memory 102) detect contact (and any movement or breaking of the contact) on touch-sensitive display system 112 and converts the detected contact into interaction with user-interface objects (e.g., one or more soft keys, icons, web pages or images) that are displayed on touch-sensitive display system 112. In an example embodiment, a point of contact between touch-sensitive display system 112 and the user corresponds to a finger of the user or a stylus.

Touch-sensitive display system 112 optionally uses LCD (liquid crystal display) technology, LPD (light emitting polymer display) technology, or LED (light emitting diode) technology, although other display technologies are used in other embodiments. Touch-sensitive display system 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch-sensitive display system 112. In an example embodiment, projected mutual capacitance sensing technology is used, such as that found in the iPhone®, iPod Touch®, and iPad® from Apple Inc. of Cupertino, Calif.

Touch-sensitive display system 112 optionally has a video resolution in excess of 100 dpi. In some embodiments, the touch screen video resolution is in excess of 400 dpi (e.g., 500 dpi, 800 dpi, or greater). The user optionally makes contact with touch- sensitive display system 112 using any suitable object or appendage, such as a stylus, a finger, and so forth. In some embodiments, the user interface is designed to work with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad (not shown) for activating or deactivating particular functions. In some embodiments, the touchpad is a touch-sensitive area of the device that, unlike the touch screen, does not display visual output. The touchpad is, optionally, a touch-sensitive surface that is separate from touch-sensitive display system 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes one or more optical sensors 164. FIG. 1A shows an optical sensor coupled with optical sensor controller 158 in I/O subsystem 106. Optical sensor(s) 164 optionally include charge-coupled device (CCD) or complementary metal-oxide semiconductor (CMOS) phototransistors. Optical sensor(s) 164 receive light from the environment, projected through one or more lens, and converts the light to data representing an image. In conjunction with imaging module 143 (also called a camera module), optical sensor(s) 164 optionally capture still images and/or video. In some embodiments, an optical sensor is located on the back of device 100, opposite touch-sensitive display system 112 on the front of the device, so that the touch screen is enabled for use as a viewfinder for still and/or video image acquisition. In some embodiments, another optical sensor is located on the front of the device so that the user's image is obtained (e.g., for selfies, for videoconferencing while the user views the other video conference participants on the touch screen, etc.).

Device 100 optionally also includes one or more contact intensity sensors 165. FIG. 1A shows a contact intensity sensor coupled with intensity sensor controller 159 in I/O subsystem 106. Contact intensity sensor(s) 165 optionally include one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor(s) 165 receive contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch- screen display system 112 which is located on the front of device 100.

Device 100 optionally also includes one or more proximity sensors 166. FIG. 1A shows proximity sensor 166 coupled with peripherals interface 118. Alternately, proximity sensor 166 is coupled with input controller 160 in I/O subsystem 106. In some embodiments, the proximity sensor turns off and disables touch-sensitive display system 112 when the multifunction device is placed near the user's ear (e.g., when the user is making a phone call).

Device 100 optionally also includes one or more tactile output generators 163. FIG. 1A shows a tactile output generator coupled with haptic feedback controller 161 in I/O subsystem 106. Tactile output generator(s) 163 optionally include one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Tactile output generator(s) 163 receive tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch-sensitive display system 112, which is located on the front of device 100.

Device 100 optionally also includes one or more accelerometers 167, gyroscopes 168, and/or magnetometers 169 (e.g., as part of an inertial measurement unit (IMU)) for obtaining information concerning the position (e.g., attitude) of the device. FIG. 1A shows sensors 167, 168, and 169 coupled with peripherals interface 118. Alternately, sensors 167, 168, and 169 are, optionally, coupled with an input controller 160 in I/O subsystem 106. In some embodiments, information is displayed on the touch-screen display in a portrait view or a landscape view based on an analysis of data received from the one or more accelerometers. Device 100 optionally includes a GPS (or GLONASS or other global navigation system) receiver (not shown) for obtaining information concerning the location of device 100.

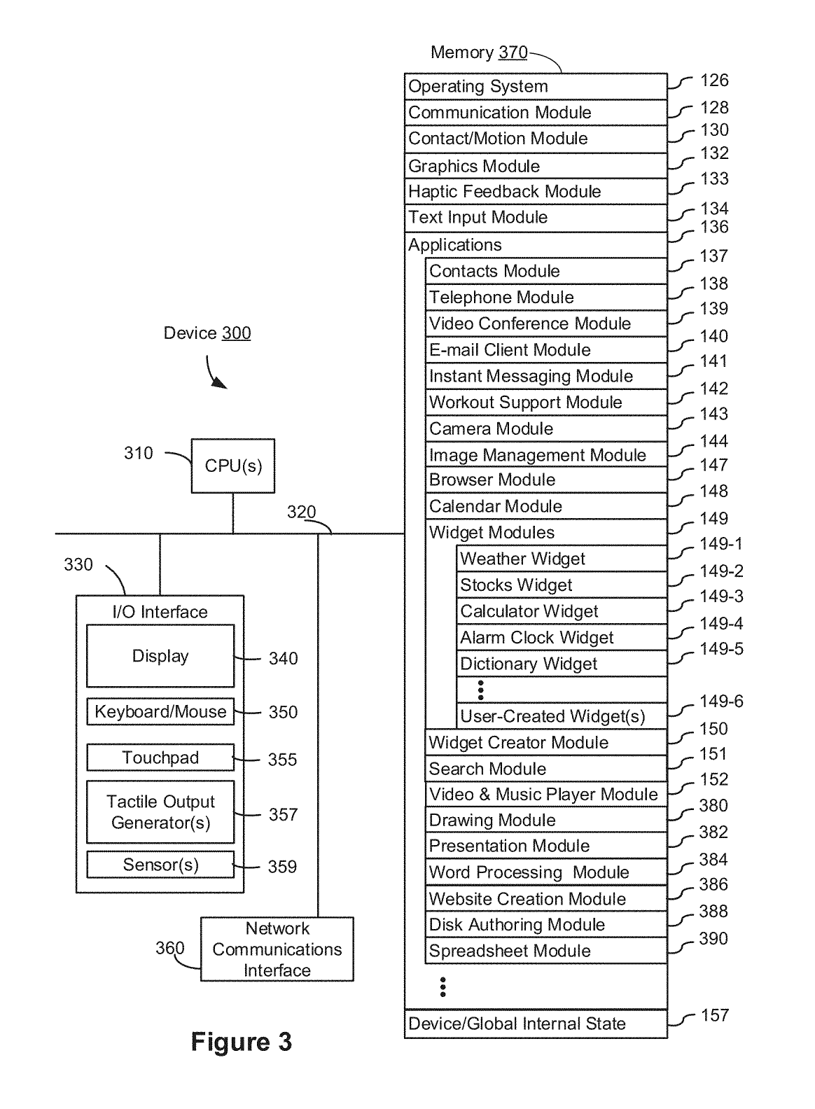

In some embodiments, the software components stored in memory 102 include operating system 126, communication module (or set of instructions) 128, contact/motion module (or set of instructions) 130, graphics module (or set of instructions) 132, haptic feedback module (or set of instructions) 133, text input module (or set of instructions) 134, Global Positioning System (GPS) module (or set of instructions) 135, and applications (or sets of instructions) 136. Furthermore, in some embodiments, memory 102 stores device/global internal state 157, as shown in FIGS. 1A and 3. Device/global internal state 157 includes one or more of: active application state, indicating which applications, if any, are currently active; display state, indicating what applications, views or other information occupy various regions of touch-sensitive display system 112; sensor state, including information obtained from the device's various sensors and other input or control devices 116; and location and/or positional information concerning the device's location and/or attitude.

Operating system 126 (e.g., iOS, Darwin, RTXC, LINUX, UNIX, OS X, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with the 30-pin connector used in some iPhone®, iPod Touch®, and iPad® devices from Apple Inc. of Cupertino, Calif. In some embodiments, the external port is a Lightning connector that is the same as, or similar to and/or compatible with the Lightning connector used in some iPhone®, iPod Touch®, and iPad® devices from Apple Inc. of Cupertino, Calif.

Contact/motion module 130 optionally detects contact with touch-sensitive display system 112 (in conjunction with display controller 156) and other touch-sensitive devices (e.g., a touchpad or physical click wheel). Contact/motion module 130 includes software components for performing various operations related to detection of contact (e.g., by a finger or by a stylus), such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts or stylus contacts) or to multiple simultaneous contacts (e.g., “multitouch”/multiple finger contacts and/or stylus contacts). In some embodiments, contact/motion module 130 and display controller 156 detect contact on a touchpad.

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (lift off) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (lift off) event. Similarly, tap, swipe, drag, and other gestures are optionally detected for a stylus by detecting a particular contact pattern for the stylus.

Graphics module 132 includes various known software components for rendering and displaying graphics on touch-sensitive display system 112 or other display, including components for changing the visual impact (e.g., brightness, transparency, saturation, contrast or other visual property) of graphics that are displayed. As used herein, the term “graphics” includes any object that can be displayed to a user, including without limitation text, web pages, icons (such as user-interface objects including soft keys), digital images, videos, animations and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 163 to produce tactile outputs at one or more locations on device 100 in response to user interactions with device 100.

Text input module 134, which is, optionally, a component of graphics module 132, provides soft keyboards for entering text in various applications (e.g., contacts 137, e-mail 140, IM 141, browser 147, and any other application that needs text input).

GPS module 135 determines the location of the device and provides this information for use in various applications (e.g., to telephone 138 for use in location-based dialing, to camera 143 as picture/video metadata, and to applications that provide location- based services such as weather widgets, local yellow page widgets, and map/navigation widgets).

Applications 136 optionally include the following modules (or sets of instructions), or a subset or superset thereof:
contacts module 137 (sometimes called an address book or contact list);
telephone module 138;
video conferencing module 139;
e-mail client module 140;
instant messaging (IM) module 141;
workout support module 142;
camera module 143 for still and/or video images;
image management module 144;
browser module 147;
calendar module 148;
widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
widget creator module 150 for making user-created widgets 149-6;
search module 151;
video and music player module 152, which is, optionally, made up of a video player module and a music player module;
notes module 153;
map module 154; and/or
online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch-sensitive display system 112, display controller 156, contact module 130, graphics module 132, and text input module 134, contacts module 137 includes executable instructions to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers and/or e-mail addresses to initiate and/or facilitate communications by telephone 138, video conference 139, e-mail 140, or IM 141; and so forth.

In conjunction with RF circuitry 108, audio circuitry 110, speaker 111, microphone 113, touch-sensitive display system 112, display controller 156, contact module 130, graphics module 132, and text input module 134, telephone module 138 includes executable instructions to enter a sequence of characters corresponding to a telephone number, access one or more telephone numbers in address book 137, modify a telephone number that has been entered, dial a respective telephone number, conduct a conversation and disconnect or hang up when the conversation is completed. As noted above, the wireless communication optionally uses any of a plurality of communications standards, protocols and technologies.

In conjunction with RF circuitry 108, audio circuitry 110, speaker 111, microphone 113, touch-sensitive display system 112, display controller 156, optical sensor(s) 164, optical sensor controller 158, contact module 130, graphics module 132, text input module 134, contact list 137, and telephone module 138, videoconferencing module 139 includes executable instructions to initiate, conduct, and terminate a video conference between a user and one or more other participants in accordance with user instructions.

In conjunction with RF circuitry 108, touch-sensitive display system 112, display controller 156, contact module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch-sensitive display system 112, display controller 156, contact module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, Apple Push Notification Service (APNs) or IMPS for Internet- based instant messages), to receive instant messages and to view received instant messages. In some embodiments, transmitted and/or received instant messages optionally include graphics, photos, audio files, video files and/or other attachments as are supported in a MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, APNs, or IMPS).

In conjunction with RF circuitry 108, touch-sensitive display system 112, display controller 156, contact module 130, graphics module 132, text input module 134, GPS module 135, map module 154, and music player module 146, workout support module 142 includes executable instructions to create workouts (e.g., with time, distance, and/or calorie burning goals); communicate with workout sensors (in sports devices and smart watches); receive workout sensor data; calibrate sensors used to monitor a workout; select and play music for a workout; and display, store and transmit workout data.

In conjunction with touch-sensitive display system 112, display controller 156, optical sensor(s) 164, optical sensor controller 158, contact module 130, graphics module 132, and image management module 144, camera module 143 includes executable instructions to capture still images or video (including a video stream) and store them into memory 102, modify characteristics of a still image or video, and/or delete a still image or video from memory 102.

In conjunction with touch-sensitive display system 112, display controller 156, contact module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch-sensitive display system 112, display system controller 156, contact module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch-sensitive display system 112, display system controller 156, contact module 130, graphics module 132, text input module 134, e-mail client module 140, and browser module 147, calendar module 148 includes executable instructions to create, display, modify, and store calendars and data associated with calendars (e.g., calendar entries, to do lists, etc.) in accordance with user instructions.

In conjunction with RF circuitry 108, touch-sensitive display system 112, display system controller 156, contact module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch-sensitive display system 112, display system controller 156, contact module 130, graphics module 132, text input module 134, and browser module 147, the widget creator module 150 includes executable instructions to create widgets (e.g., turning a user-specified portion of a web page into a widget).

In conjunction with touch-sensitive display system 112, display system controller 156, contact module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch-sensitive display system 112, display system controller 156, contact module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present or otherwise play back videos (e.g., on touch- sensitive display system 112, or on an external display connected wirelessly or via external port 124). In some embodiments, device 100 optionally includes the functionality of an MP3 player, such as an iPod (trademark of Apple Inc.).

In conjunction with touch-sensitive display system 112, display controller 156, contact module 130, graphics module 132, and text input module 134, notes module 153 includes executable instructions to create and manage notes, to do lists, and the like in accordance with user instructions.

In conjunction with RF circuitry 108, touch-sensitive display system 112, display system controller 156, contact module 130, graphics module 132, text input module 134, GPS module 135, and browser module 147, map module 154 includes executable instructions to receive, display, modify, and store maps and data associated with maps (e.g., driving directions; data on stores and other points of interest at or near a particular location; and other location-based data) in accordance with user instructions.

In conjunction with touch-sensitive display system 112, display system controller 156, contact module 130, graphics module 132, audio circuitry 110, speaker 111, RF circuitry 108, text input module 134, e-mail client module 140, and browser module 147, online video module 155 includes executable instructions that allow the user to access, browse, receive (e.g., by streaming and/or download), play back (e.g., on the touch screen 112, or on an external display connected wirelessly or via external port 124), send an e-mail with a link to a particular online video, and otherwise manage online videos in one or more file formats, such as H.264. In some embodiments, instant messaging module 141, rather than e-mail client module 140, is used to send a link to a particular online video.

Each of the above identified modules and applications correspond to a set of executable instructions for performing one or more functions described above and the methods described in this application (e.g., the computer-implemented methods and other information processing methods described herein). These modules (i.e., sets of instructions) need not be implemented as separate software programs, procedures or modules, and thus various subsets of these modules are, optionally, combined or otherwise re-arranged in various embodiments. In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating example components for event handling in accordance with some embodiments. In some embodiments, memory 102 (in FIGS. 1A) or 370 (FIG. 3) includes event sorter 170 (e.g., in operating system 126) and a respective application 136-1 (e.g., any of the aforementioned applications 136, 137-155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display system 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display system 112, as part of a multi-touch gesture). Peripherals interface 118 transmits information it receives from I/O subsystem 106 or a sensor, such as proximity sensor 166, accelerometer(s) 167, gyroscope(s) 168, magnetometer(s) 169, and/or microphone 113 (through audio circuitry 110). Information that peripherals interface 118 receives from I/O subsystem 106 includes information from touch-sensitive display system 112 or a touch-sensitive surface.

In some embodiments, event monitor 171 sends requests to the peripherals interface 118 at predetermined intervals. In response, peripherals interface 118 transmits event information. In other embodiments, peripheral interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views, when touch-sensitive display system 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (i.e., the first sub-event in the sequence of sub-events that form an event or potential event). Once the hit view is identified by the hit view determination module, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver module 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit (not shown) or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177 or GUI updater 178 to update the application internal state 192. Alternatively, one or more of the application views 191 includes one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170, and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event 187 include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first lift-off (touch end) for a predetermined phase, a second touch (touch begin) on the displayed object for a predetermined phase, and a second lift-off (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display system 112, and lift-off of the touch (touch end). In some embodiments, the event also includes information for one or more associated event handlers 190.

In some embodiments, event definition 187 includes a definition of an event for a respective user-interface object. In some embodiments, event comparator 184 performs a hit test to determine which user-interface object is associated with a sub-event. For example, in an application view in which three user-interface objects are displayed on touch-sensitive display system 112, when a touch is detected on touch-sensitive display system 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event 187 also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module 145. In some embodiments, object updater 177 creates and updates objects used in application 136-1. For example, object updater 176 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input-devices, not all of which are initiated on touch screens. For example, mouse movement and mouse button presses, optionally coordinated with single or multiple keyboard presses or holds; contact movements such as taps, drags, scrolls, etc., on touch-pads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen (e.g., touch-sensitive display system 112, FIG. 1A) in accordance with some embodiments. The touch screen optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward) and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also includes one or more physical buttons, such as “home” or menu button 204. As described previously, menu button 204 is, optionally, used to navigate to any application 136 in a set of applications that are, optionally executed on device 100. Alternatively, in some embodiments, the menu button is implemented as a soft key in a GUI displayed on the touch-screen display.

In some embodiments, device 100 includes the touch-screen display, menu button 204, push button 206 for powering the device on/off and locking the device, volume adjustment button(s) 208, Subscriber Identity Module (SIM) card slot 210, head set jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In some embodiments, device 100 also accepts verbal input for activation or deactivation of some functions through microphone 113. Device 100 also, optionally, includes one or more contact intensity sensors 165 for detecting intensity of contacts on touch-sensitive display system 112 and/or one or more tactile output generators 163 for generating tactile outputs for a user of device 100.

FIG. 3 is a block diagram of an example multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPU's) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch-screen display. I/O interface 330 also optionally includes a keyboard and/or mouse (or other pointing device) 350 and touchpad 355, tactile output generator 357 for generating tactile outputs on device 300 (e.g., similar to tactile output generator(s) 163 described above with reference to FIG. 1A), sensors 359 (e.g., touch-sensitive, optical, contact intensity, proximity, acceleration, attitude, and/or magnetic sensors similar to sensors 112, 164, 165, 166, 167, 168, and 169 described above with reference to FIG. 1A). Memory 370 includes high-speed random access memory, such as DRAM, SRAM, DDR RAM or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (FIG. 1A) optionally does not store these modules.

Each of the above identified elements in FIG. 3 are, optionally, stored in one or more of the previously mentioned memory devices. Each of the above identified modules corresponds to a set of instructions for performing a function described above. The above identified modules or programs (i.e., sets of instructions) need not be implemented as separate software programs, procedures or modules, and thus various subsets of these modules are, optionally, combined or otherwise re-arranged in various embodiments. In some embodiments, memory 370 optionally stores a subset of the modules and data structures identified above. Furthermore, memory 370 optionally stores additional modules and data structures not described above.

Attention is now directed towards embodiments of user interfaces (“UI”) that are, optionally, implemented on portable multifunction device 100.

FIG. 4A illustrates an example user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser”; and
   Icon 422 for video and music player module 152, also referred to as iPod (trademark of Apple Inc.) module 152, labeled “iPod”; and
Icons for other applications, such as:
   Icon 424 for IM module 141, labeled “Text”;
   Icon 426 for calendar module 148, labeled “Calendar”;
   Icon 428 for image management module 144, labeled “Photos”;
   Icon 430 for camera module 143, labeled “Camera”;
   Icon 432 for online video module 155, labeled “Online Video”;
   Icon 434 for stocks widget 149-2, labeled “Stocks”;
   Icon 436 for map module 154, labeled “Map”;
   Icon 438 for weather widget 149-1, labeled “Weather”;
   Icon 440 for alarm clock widget 169-6, labeled “Clock”;
   Icon 442 for workout support module 142, labeled “Workout Support”;
   Icon 444 for notes module 153, labeled “Notes”; and
   Icon 446 for a settings application or module, which provides access to settings for device 100 and its various applications 136.

It should be noted that the icon labels illustrated in FIG. 4A are merely examples. For example, in some embodiments, icon 422 for video and music player module 152 is labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an example user interface on a device (e.g., device 300, FIG. 3) with a touch-sensitive surface 451 (e.g., a tablet or touchpad 355, FIG. 3) that is separate from the display 450. Device 300 also, optionally, includes one or more contact intensity sensors (e.g., one or more of sensors 359) for detecting intensity of contacts on touch-sensitive surface 451 and/or one or more tactile output generators 359 for generating tactile outputs for a user of device 300.

FIG. 4B illustrates an example user interface on a device (e.g., device 300, FIG. 3) with a touch-sensitive surface 451 (e.g., a tablet or touchpad 355, FIG. 3) that is separate from the display 450. Many of the examples that follow will be given with reference to a device that detects inputs on a touch-sensitive surface that is separate from the display, as shown in FIG. 4B.

As used herein, the term “focus selector” refers to an input element that indicates a current part of a user interface with which a user is interacting. In some implementations that include a cursor or other location marker, the cursor acts as a “focus selector,” so that when an input (e.g., a press input) is detected on a touch-sensitive surface (e.g., touchpad 355 in FIG. 3 or touch-sensitive surface 451 in FIG. 4B) while the cursor is over a particular user interface element (e.g., a button, window, slider or other user interface element), the particular user interface element is adjusted in accordance with the detected input. In some implementations that include a touch-screen display (e.g., touch-sensitive display system 112 in FIG. 1A or the touch screen in FIG. 4A) that enables direct interaction with user interface elements on the touch-screen display, a detected contact on the touch-screen acts as a “focus selector,” so that when an input (e.g., a press input by the contact) is detected on the touch-screen display at a location of a particular user interface element (e.g., a button, window, slider or other user interface element), the particular user interface element is adjusted in accordance with the detected input. In some implementations, focus is moved from one region of a user interface to another region of the user interface without corresponding movement of a cursor or movement of a contact on a touch-screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch-screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

### User Interfaces and Associated Processes

Attention is now directed towards embodiments of user interfaces (“UI”) and associated processes that may be implemented on an electronic device, such as portable multifunction device (PMD) 100 or device 300, with a display, a touch-sensitive surface, and one or more sensors to detect intensity of contacts with the touch-sensitive surface.

FIGS. 5A-5P illustrate example user interfaces for managing data stored at a storage location in accordance with some embodiments. The user interfaces in these figures are used to illustrate the processes described below, including the processes in FIGS. 6A-6E. Although some of the examples which follow will be given with reference to inputs on a touch-sensitive surface 451 that is separate from the display 450, in some embodiments, the device detects inputs on a touch-screen display (where the touch-sensitive surface and the display are combined), as shown in FIG. 4A.

It is to be appreciated that, in embodiments in which the touch-sensitive surface and the display are combined, as shown in FIG. 4A, the user interface may not include many of the features described below, such as the cursor 501 or various windows. Nevertheless, aspects described herein with respect the user interfaces illustrated in FIGS. 5A-5P and the processes in FIGS. 6A-6E can be implemented on devices including touch-screen displays.

FIG. 5A illustrates a user interface 500 including a storage usage user interface 520. The user interface 500 is displayed on a display 450 of a device. The user interface 500 includes a dock 505 at a bottom of the user interface 500 including a number of dock icons 506A-506C for opening respective applications of the device. The user interface 500 also includes a cursor 501 for interacting with the user interface 500.

In FIG. 5A, the user interface 500 includes a storage usage user interface 520 displayed within a window. The storage usage user interface 520 includes information regarding usage of storage at one or more storage locations with limited available storage capacity. Each storage location can be, for example, an internal storage device of the device (e.g., a hard disk of the device), an external storage device coupled to the device (e.g., an external hard drive, a RAID device, or an internal hard drive of another device connected to the device, such as a hard drive of a smartwatch), a partition of an internal or external storage device (e.g., a boot partition of the device), or a cloud storage location.

The storage usage user interface 520 includes a first graphical storage usage representation 521A for a first storage location indicating that 75 GB of data is stored at the first storage location out of a limited available storage capacity of 100 GB. The first graphical storage usage representation 521A includes a bar including a number of used sections 522A-522C, each used section 522A-522C being representative of an amount of storage at the storage location used by respective data types (e.g., application, documents, media, etc.). The bar includes an unused section 523 representative of amount of unused storage at the storage location. In various implementations, the size of the sections 522A-522C, 523 is representative of the amount of storage. The storage usage user interface 520 also includes a second graphical storage usage representation 521B for a second storage location.

The storage usage user interface 520 includes a first management affordance 524A displayed in association with the first graphical storage usage representation 521A (and a second management affordance 524B displayed in association with the second graphical storage usage representation 521B).

FIG. 5A illustrates that the cursor 501 is at a location of the first management affordance 524A. In response to detecting selection of the first management affordance 524A, the user interface 500 displays a data storage management user interface 530, as shown in FIG. 5D and described further below.

FIG. 5B illustrates a user interface 500 including a threshold notification 525 displayed within a window. The threshold notification 525 includes text 526 indicating that an amount of data stored at the storage location exceeds a threshold. The threshold can be, for example, a percentage of the limited available storage capacity of the storage location, e.g., 90 percent or 100 percent. The threshold can be, as another example, an amount less than the limited available storage capacity of the storage location, e.g., 1 GB, 2 GB, 5 GB, or 10 GB less than the limited available storage capacity of the storage location. The threshold notification 525 also includes the first management affordance 524A.

FIG. 5B illustrates that the cursor 501 is at a location of the first management affordance 524A. In response to detecting selection of the first management affordance 524A, the user interface 500 displays a data storage management user interface 530, as shown in FIG. 5D and described further below.

FIG. 5C illustrates a user interface 500 including an operation failure notification 527 displayed within a window. The operation failure notification 527 includes text 528 indicating that the amount of unused storage at the storage location is insufficient to perform an operation requested by a user. The operation can be, for example, the installation of an application or storage a set of one or more files that the user has requested be stored at the storage location. The operation failure notification 527 also includes the first management affordance 524A.

FIG. 5C illustrates that the cursor 501 is at a location of the first management affordance 524A. In response to detecting selection of the first management affordance 524A, the user interface 500 displays a data storage management user interface 530, as shown in FIG. 5D and described further below.

FIG. 5D illustrates a user interface 500 including a data storage management user interface 530 within a window. The data storage management user interface 530 is displayed in response to detecting a management input indicative of a request to manage data stored at the direction of the device at a storage location. For example, the data storage management user interface 530 can be displayed in response to selecting the first management affordance 524A of the storage usage user interface 520 of FIG. 5A or selecting the first management affordance 524A of a warning notification indicating that an amount of used storage at the storage location meets warning criteria, such as the threshold notification 525 of FIG. 5B or the operation failure notification 527 of FIG. 5C. As another example, the data storage management user interface 530 can be displayed in response to detecting selection of a management affordance within a settings menu or through other user input operations.

The data storage management user interface 530 includes a first section 531 including, in FIG. 5D, a recommendations user interface 541 including a plurality of data storage management affordances 533A-533D respectively associated with a plurality of data storage management operations. The data storage management user interface 530 includes a second section 532 including a plurality of view affordances 534A-534G for changing the user interface displayed in the first section 531. Although the view affordances 534A-534G are described below as changing the user interface of the first section 531, it is to be appreciated that, in some embodiments, the view affordances 534A-534G open new windows to display the user interfaces described with respect to the respective view affordances 534A-534G. A set of the view affordances 534B-534G includes an amount of data stored at the storage location associated with the respective view. The second section 532 also displays an amount of data stored at the storage location (e.g., 75 GB) and the limited available storage capacity of the storage location (e.g., 100 GB).

In some implementations, the plurality of data storage management operations correspond to data associated with an active user (e.g., a logged-in user). Thus, the plurality of view affordances includes an other users view affordance 534F displayed in association with an indication of an amount of data stored at the storage location associated with other users who are not the currently active user. Thus, in some embodiments, the active user is not provided with the option to delete data associated with other users who are not the currently active user, but the amount of storage used by other users is displayed to the active user to help the active user better understand how the available storage at the storage location is being used.

In some implementations, the plurality of data storage management operations perform actions with respect to multiple users (e.g., all registered users of the device). In such implementations, the data storage management user interface 530 may lack the other users view affordance 534F.

The recommendations user interface 541 can be displayed in the first section 531 by default upon displaying the data storage management user interface 530 and/or in response to detecting selection of the recommendations view affordance 534A. The recommendations user interface 541 includes a delete cached mail affordance 533A associated with delete cached mail operation. The delete cached mail affordance 533A is displayed in associated with descriptive text 535A that describes the delete cached mail operation and includes an amount of storage at the storage location freed by the delete cached mail operation.

FIG. 5D illustrates that the cursor 501 is at a location of the delete cached mail affordance 533A. In response to detecting selection of the delete cached mail affordance 533A, the user interface 500 displays a confirmation user interface 551A, as shown in FIG. 5E and described further below.

FIG. 5E illustrates the user interface 500 in response to detecting selection of the delete cached mail affordance 533A of FIG. 5D. The user interface 500 includes a confirmation user interface 551A with a confirm affordance 551B for performing the delete cached mail operation and a cancel affordance 551C for canceling performance of the delete cached mail operation. The confirmation user interface 551A includes an auto-repeat affordance 551D in the form of a checkbox which, when selected, changes to an on state. When the confirm affordance 551B is selected with the auto-repeat affordance 551D in the on state, the device performs the delete cached mail operation and automatically performs the delete cached mail operation at a later time. For example, the device can perform the delete cached mail operation again after 30 days, perform the cached mail operation periodically every 30 days, or can perform the delete cached mail operation daily to delete cached mail attachments that have been stored for 30 days or more.

FIG. 5E illustrates that the cursor 501 is at a location of the confirm affordance 551B. In response to detecting selection of the confirm affordance 551B, the device deletes cached mail attachments that are stored at the storage location but can be downloaded from a mail server to the storage location if and when desired by a user.

FIG. 5F illustrates the user interface 500 in response to detecting selection of the confirm affordance 551B of FIG. 5E. The data storage management user interface 530 of FIG. 5F differs from the data storage management user interface 530 of FIG. 5D in response to deleting the cached mail attachments. For example, the amount of data stored at the storage location displayed in the second section 532 is reduced (from 75 GB in FIG. 5D to 74 GB in FIG. 5F) and the delete cached mail affordance 533A is grayed out because, as indicated by the descriptive text 535A, there are no cached mail attachments to delete.

The recommendations user interface 541 of FIG. 5F, like the recommendations user interface 541 of FIG. 5D, includes an empty trash affordance 533C associated with an empty trash operation. The empty trash affordance 533C is displayed in associated with descriptive text 535C that describes the empty trash operation and includes an amount of storage at the storage location freed by the empty trash operation.

FIG. 5F illustrates that the cursor 501 is at a location of the empty trash affordance 533C. In response to detecting selection of the empty trash affordance 533C, the device permanently deletes items that have been marked for deletion (e.g., empties a trash container).

FIG. 5G illustrates the user interface 500 in response to detecting selection of the empty trash affordance 533C in FIG. 5F. The user interface 500, like the user interface of FIG. 5F, includes the data storage management user interface 530. The data storage management user interface 530 of FIG. 5G differs from the data storage management user interface 530 of FIG. 5G in response to emptying the trash. For example, the amount of data stored at the storage location displayed in the second section 532 is reduced (from 74 GB in FIG. 5F to 72 GB in FIG. 5G) and the empty trash affordance 533C is grayed out (or otherwise shown as inactive) because, as indicated by the descriptive text 535C, there are no files marked for deletion (e.g., in the trash bin).

Thus, in some implementations, the plurality of data storage management operations includes one or more data storage management operations that immediately free an amount of storage at the storage location. For example, the data storage management operations include a delete cached mail operation (as shown in FIG. 5D) that deletes cached mail attachments that are stored at the storage location but can be downloaded from a mail server to the storage location if and when desired by a user. As another example, the data storage management operations include an empty trash operation (as shown in FIG. 5F) that permanently deletes items that have been marked for deletion. In various implementations, the data storage management operations can include other data storage management operations that immediately free an amount of storage at the storage location. For example, the data storage management operations can include a delete applications operations that deletes application that meet a heuristic (e.g., application that are unused or infrequently used and/or have a size below a threshold) and can be freely downloaded from an application store if and when desired by a user. As another example, the data storage management operations can include a delete media operation that deletes media items that meet a heuristic (e.g., songs that are unplayed or infrequently played or movies and television episodes that have been consumed) and can be downloaded from a media platform if and when desired by a user.

As shown in FIGS. 5D-5F, in some implementations, the user interface 500 includes a confirmation user interface 551A including a confirmation affordance 551B which is selectable to initiate a respective data storage management operation. However, as shown in FIGS. 5F-5G, in some implementations, the user interface 500 does not include a confirmation user interface and a data storage management operation is initiated in response to detecting selection of the respective data storage management affordance 533A-533D.

FIG. 5G illustrates that the cursor 501 is at a location of the cloud photo storage affordance 533B. In response to detecting selection of the cloud photo storage affordance 533B, the device for displays an options user interface 552A, as shown in FIG. 5H and described further below.

FIG. 5H illustrates the user interface 500 in response to detecting selection of the cloud photo storage affordance 533B of FIG. 5G. The user interface 500 includes an options user interface 552A with a number of option affordances 552B-552D for selecting a setting of a cloud photo storage operation. In some implementations, the options user interface 552A is not displayed and the cloud photo storage operation is performed without further user interaction using a default setting.

FIG. 5H illustrates that the cursor 501 is at a location of a one-week option affordance 552C. In response to detecting selection of the one-week option affordance 552C, the device is configured to continually move photos that are stored at the storage location that are at least one week old to a remote storage location. Thus, as time passes, photos that are stored at the storage location are deleted (but saved at the remote storage location).

Thus, in some implementations, the plurality of data storage management operations includes one or more data storage management operations that enable a reduction of data stored at the storage location. For example, the data storage management operations include a cloud photo storage operation (as shown in FIG. 5H) that configures the device to continually move photos that are stored at the storage location that are at least a threshold ago to a remote storage location. In various implementations, the data storage management operations can include other data storage management operations that enable a reduction of data stored at the storage location. For example, the data storage management operations can include a cloud documents storage operation that configured the device continually move documents that are stored at the storage location that have not been accessed for at least a threshold amount of time to a remote storage location. As another example, the data storage management operations can include a limit media operation that, so long as a threshold amount media is maintained at the storage location, deletes media items that meet a heuristic (e.g., songs that are unplayed or infrequently played or movies and television episodes that have been consumed) and can be downloaded from a media platform when additional storage is required.

FIG. 5I illustrates the user interface 500 in response to detecting selection of the one-week option affordance 552C of FIG. 5H. FIG. 5I illustrates that the cursor 501 is at a location of an applications view affordance 534B. In response to detecting selection of the applications view affordance 534B, the device displays an applications storage management user interface 542 in the first section 531 as shown in FIG. 5J and described further below. As mentioned above, in some embodiments, selection of the applications view affordance 534B results in the display of the applications storage management user interface 542 in a new window.

FIG. 5J illustrates the user interface 500 in response to detecting selection of the applications view affordance 534B in FIG. 5I. In FIG. 5J, the first section 531 of the user interface 500 displays an applications storage management user interface 542 including a list of applications installed at the storage location. Each element of the list of applications includes an application identifier 561C (e.g., a name of the application) for an application, a size 561A of the application, a last-opened date 561B of when the application was last opened, and a delete affordance 561D for uninstalling the application. In various implementations, each element of the list of applications can include additional information, such as an installation date of when the application was installed at the storage location, a use-frequency indicator indicative of how frequently the application is opened, or an availability indicator indicative of whether the application can be freely downloaded from an application store if and when desired by a user. In some embodiments, only application that can be freely downloaded from the application store are displayed in the list of applications.

In some implementations, the list of applications is, by default (e.g., in response to detecting selection of the applications view affordance 534B), sorted by size 561A. In FIG. 5J, the applications storage management user interface 542 includes sort affordances 562A-562C for sorting by size, last-opened date, and name. In some embodiments, the applications storage management user interface 542 comprises other sort affordances to sort the list of applications by other variables, such as installation date.

FIG. 5J illustrates that the cursor 501 is at a location of the media view affordance 534C. In response to detecting selection of the media view affordance 534C, the device displays a media storage management user interface 543 in the first section 531 as shown in FIG. 5K and described further below. As mentioned above, in some embodiments, selection of the media view affordance 534C results in the display of the media storage management user interface 543 in a new window.

FIG. 5K illustrates the user interface 500 in response to detecting selection of the media view affordance 534C in FIG. 5J. In FIG. 5K, the first section 531 of the user interface 500 displays a media storage management user interface 543 including a list of media items stored at the storage location. Each element of the list of media items includes a media item identifier 563C (e.g., a name of the media item) for a media item, a size 563A of the media item, a last-consumed date 563B of when the media item was last consumed, a consumption indicator 563D indicative of consumption level of the media item (e.g., an amount the media item that has been consumed), and a delete affordance 563E for deleting the media item. In various implementations, each element of the list of media items can include additional information, such as a download date of when the media item was first stored at the storage location, a duration of the media item (e.g., a runtime), or an availability indicator indicative of whether the media item can be freely downloaded from a media store if and when desired by a user. In some embodiments, only media items that can be freely downloaded from the media store are displayed in the list of media items.

The media item identifier 563C can include, in various implementations, one or more of a title (e.g., a movie title or a song title), an album title, an artist or author, an episode number, a release date (e.g., for a podcast), or other identifying information. The consumption indicator 563D can be a binary indicator that indicates whether or not a media item has been consumed. Thus, as an example, movies or television episodes that have been watched can easily be identified for deletion. The consumption indicator 563C can indicate a percentage of the media item that has been consumed. Thus, as an example, movies that have been partially watched (but not completed) can be identified for deletion (as the user may have disliked the movie and be uninterested in finishing the movie). The consumption indicator 563C can indicate a frequency of consumption. Thus, as an example, songs that are frequently listened to can be distinguished from songs that are infrequently listened to that a user may wish to delete.

In some embodiments, as illustrated in FIG. 5K, the list of media items includes visually separated sub-lists of media items of particular media types. For example, in FIG. 5K, the list of media items includes a first list of movies and a second list of television shows. In various implementations, the sub-lists can include lists for movies, television shows, songs, books, audiobooks, or podcasts.

In FIG. 5K, the media storage management user interface 543 includes sort affordances 564A-564D for sorting each sub-list by size, last-consumed date, and name. In some embodiments, the media storage management user interface 543 includes other sort affordances to sort the sub-lists by other variables, such as consumption level, download date, or duration.

FIG. 5K illustrates that the cursor 501 is at a location of the documents view affordance 534D. In response to detecting selection of the documents view affordance 534D, the device displays a documents storage management user interface 544 in the first section 531 as shown in FIG. 5L and described further below. As mentioned above, in some embodiments, selection of the documents view affordance 534D results in the display of the documents storage management user interface 544 in a new window.

FIG. 5L illustrates the user interface 500 in response to detecting selection of the documents view affordance 534D in FIG. 5K. In FIG. 5L, the first section 531 of the user interface 500 displays a documents storage management user interface 544 including a list of document items stored at the storage location. In some embodiments, the list of document items includes only document items stored at the storage location having a size greater than a threshold. In some embodiments, the list of document items excludes items that are visible in other storage management user interfaces of the data storage management user interface 530. Thus, as illustrated in FIG. 5L, the list of document items does not include media items, applications, cached mail attachments, or system files. In other embodiments, the list of document items includes one or more items (or item types) that are visible in other storage management user interfaces of the data storage manage user interface 530. The document items can include, for example, text documents, spreadsheet documents, presentation slide decks, diagramming and vector graphics documents, or other documents.

Each element of the list of document items includes a document item identifier 565D (e.g., a name of the document item) for a document item, a size 565A of the document item, a created date 565B indicative of when the document item was created, an opened data 565C indicative of when the document item was last accessed, and a delete affordance 565E for deleting the media item.

In some embodiments, the list of document items includes visually separated sub-lists of document items of particular media types. For example, the list of document items can include a first sub-list of text documents and a second sub-list of spreadsheet documents.

In some implementations, the list of applications is, by default (e.g., in response to detecting selection of the documents view affordance 534D), sorted by size 565A. In FIG. 5L, the document storage management user interface 544 includes sort affordances 566 for sorting the list by size, created date, opened date, and name. In some embodiments, the document storage management user interface 544 includes other sort affordances to sort the list by other variables, such as document type.

The documents storage management user interface 544 includes a view toggle affordance 567 for switching between the documents storage management user interface 544 and a file storage management user interface 545 illustrated in FIG. 5M and described below. FIG. 5L illustrates that the cursor 501 is at a location of the view toggle affordance 567. In response to detecting selection of the view toggle affordance 567, the device displays a file storage management user interface 545 in the first section 531 as shown in FIG. 5M and described further below. In some embodiments, the storage management user interface 545 is also displayed in response to detecting selection of the file view affordance 534E.

FIG. 5M illustrates the user interface 500 in response to detecting selection of the view toggle affordance 567 in FIG. 5L. In FIG. 5M, the first section 531 of the user interface 500 displays a file storage management user interface 545 including a navigable file system hierarchy. The navigable file system hierarchy, in FIG. 5M, includes a list of file system nodes (e.g., files and/or folders). Each element of the list includes a node identifier 568B (e.g., a name of the file or folder) for a node, a size of the node 568A, and a delete affordance 568C for deleting the node.

In some implementations, the list of file system nodes is, by default (e.g., in response to detecting selection of the file view affordance 534E), sorted by size 568A. In FIG. 5M, the file storage management user interface 545 includes sort affordances 569A for sorting the list by name or size. In some embodiments, the file storage management user interface 545 includes other sort affordances to sort the list by other variables, such as last-accessed date.

FIG. 5M illustrates that the cursor 501 is at a location of a first one of the elements of the list of file system nodes. In response to detecting selection of the first one of the elements of the list of file system nodes, the file storage management user interface 545 displays a list of sub-nodes as shown in FIG. 5N and described further below.

FIG. 5N illustrates the user interface 500 in response to detecting selection of the first one of the elements of the list of file system nodes in FIG. 5M. In FIG. 5N, the navigable file system hierarchy includes a list of file system sub-nodes of the selected node. Each element of the list includes a node identifier 568E (e.g., a node of the file or folder) for the sub-node, a size of the sub-node 568D, and a delete affordance 568F for deleting the sub-node. In some implementations, the list of file system sub-nodes is, by default (e.g., in response to detecting selection of the node), sorted by size 568D. In FIG. 5M, the file storage management user interface 545 includes sort affordances 569B for sorting the list by name or size. In some embodiments, the file storage management user interface 545 includes other sort affordances to sort the list by other variables, such as last-accessed date. Thus, nodes in the navigable file system hierarchy are expandable to display sub-nodes sorted by size and displayed with an indication of the size of the sub-node and a delete affordance to delete the sub-node.

FIG. 5N illustrates that the cursor 501 is at a location of a dock icon 506C corresponding to a file system viewer. In response to detecting selection of the dock icon 506C, the device displays a file system viewer user interface 570 as shown in FIG. 50 and described further below.

FIG. 50 illustrates the user interface 500 in response to detecting selection of the dock icon 506C corresponding to the file system viewer. In FIG. 50, the user interface 500 includes a file system viewer user interface 570 displayed in a new window. The file system viewer user interface 570 includes a list of file system nodes. Unlike the list of file system nodes in the file storage management user interface 545, the list of file system nodes in the file system viewer user interface 570 does not include indications of the size of the node or delete affordances for deleting the nodes. Further, the list of file system nodes is sorted alphabetically by name and the file system viewer user interface 570 does not include sort affordances for sorting the list.

FIG. 50 illustrates that the cursor 501 is at a location of a node. In response to detecting selection of the node, the file system viewer user interface 570 includes a list of sub-nodes as shown in FIG. 5P and described further below.

FIG. 5P illustrates the user interface 500 in response to detecting selection of the node in FIG. 50. The first system view user interface 570 includes a list of sub- nodes sorted alphabetically by name and lacking an indication of size and further lacking a delete affordance for deleting the sub-nodes.

FIGS. 6A-6E illustrate a flow diagram of a method 600 of managing data stored at a storage location in accordance with some embodiments. The method 600 is performed at an electronic device (e.g., the portable multifunction device 100 in FIG. 1A, or the device 300 in FIG. 3) with a display and an input device. In some embodiments, the display is a touch-screen display and the input device is a touch-sensitive surface on or integrated with the display. In some embodiments, the display is separate from the input device (which may be a touch-sensitive surface). Some operations in method 600 are, optionally, combined and/or the order of some operations is, optionally, changed.

As described below, the method 600 provides an intuitive way to manage data stored at a storage location. The method reduces the cognitive burden on a user when managing data stored at a storage location, thereby creating a more efficient human- machine interface. For battery-operated electronic devices, enabling a user to manage data stored at a storage location faster and more efficiently conserves power and increases the time between battery charges.

The device detects (602), via the input device, a management input indicative of a request to manage data stored at the direction of the device at a storage location with a limited available storage capacity. In some embodiments, the device displays (604), on the display, a storage usage user interface including information regarding usage of storage at the storage location and the management input corresponds to selection of a management affordance displayed in the storage usage user interface. For example, in FIG. 5A, the device displays a storage usage user interface 520 including a first management affordance 524A. As another example, in FIG. 5B, the device displays a threshold notification 525 (also a storage usage user interface) including the first management affordance 524A. As another example, in FIG. 5C, the device displays an operation failure notification 527 (also a storage usage user interface) including the first management affordance.

In some embodiments, the information regarding usage of storage at the storage location includes (606) a graphical representation of the usage of storage at the storage location. For example, in FIG. 5A, the storage usage user interface 520 includes a first graphical storage usage representation 521A. In some embodiments, the information regarding usage of storage at the storage location includes (608) a warning notification indicating that an amount of data stored at the storage location meets warning criteria. In some embodiments, the warning criteria includes (610) a criterion that is met when the amount of data stored at the storage location exceeds a threshold. For example, in FIG. 5B, the threshold notification 525 includes text 526 indicating that an amount of data stored at the storage location exceeds a threshold. In some embodiments, the warning criteria includes (612) a criterion that is met when the amount of data stored at the storage location provides unused storage at the storage location that is insufficient to perform an operation requested by a user. For example, in FIG. 5C, the operation failure notification 527 include text 528 indicating that the amount of unused storage at the storage location is insufficient to perform an operation requested by a user.

In response to detecting the management input, the device displays (614), on the display, a data storage management user interface that includes a plurality of data storage management affordances respectively associated with a plurality of data storage management operations. The disk storage management user interface provides an efficient mechanism for a user to manage disk storage, thus reducing the amount of user interaction to perform disk storage management operations. The reduction in user interaction reduces wear-and-tear of the device. The reduction in user interaction also results in faster initiation of the performance of the disk storage management operations and, thus, reduces power drain to perform the disk storage management operations, increasing battery life of the device. Further, providing an efficient mechanism for a user to manage disk storage increases the likelihood that a user will perform such management and improve performance of the device. For example, in FIG. 5D, the device displays the data storage management user interface 530 including a plurality of data storage management affordances 533A-533D respectively associated with a plurality of data storage management operations.

In some embodiments, at least one of plurality of data storage management affordances is (616) selectable to initiate a respective data storage management operation. For example, in FIG. 5F, selection of the empty trash affordance 533C initiates (and completes) the empty trash operation without further user input (as illustrated in FIG. 5G).

In some embodiments, at least one of the plurality of data storage management affordances is (618) selectable to display a confirmation affordance which is selectable to initiate a respective data storage management operation. For example, in FIG. 5D, selection of the delete cached mail affordance 533A causes display of a confirm affordance 551B in the confirmation user interface 551A which, when selected, initiates (and completes) the delete cached mail operation without further user input (as illustrated in FIG. 5F).

In some embodiments, the plurality of data storage management operations includes (620) one or more data storage management operations that immediately free an amount of storage at the storage location. In some embodiments, the one or more data storage management operations that immediately free an amount of storage at the storage location includes (622) one or more of an operation that permanently deletes items that have been marked for deletion, an operation that deletes one or more applications, an operation that deletes a cache of one or more applications, or an operation that removes media that meets predefined criteria. For example, in FIG. 5D, the data storage management user interface 530 includes an empty trash affordance 533C for permanently deleting items that have been marked for deletion and, thus, immediately freeing an amount of storage at the storage location. As another example, in FIG. 5D, the data storage management user interface 530 includes a delete cached mail affordance 533A for deleting cached mail attachments of a mail application and, thus, immediately freeing an amount of storage at the storage location.

In some embodiments, the plurality of data storage management operations includes (624) one or more data storage management operations that enable a reduction of data stored at the storage location. With less data stored at the storage location, memory reads are faster and more storage is available for use as virtual processor cache, speeding up other operations. Further, by storing less data at the storage location, fewer or smaller (and less expensive) storage devices are needed at the storage location (e.g., within the device, coupled to the device, or at a cloud storage facility). In some embodiments, the one or more data storage management operations that enable a reduction of data stored at the storage location includes (626) an operation that stores data stored at the storage location at a remote storage location or an operation to allow deletion of media items while maintaining at least a threshold amount of media items. For example, in FIG. 5D, the data storage management user interface 530 includes a cloud photo storage affordance 533B for configuring the device to continually move photos that are stored at the storage location that are at least certain time period old to a remote storage location. Thus, a reduction of data stored at the storage location is enabled because, as time passes, photos that are stored at the storage location are deleted (but saved at the remote storage location).

Generally, the plurality of data storage management operations includes (628) a first data storage management affordance that is associated with a first data storage management operation that is configured to be performed on data stored at the direction of the device at the storage location and is displayed concurrently with a description of the first data storage management operation. For example, in FIG. 5D, the data storage management user interface 530 includes an empty trash affordance 533C that is associated with an empty trash operation that is performed on data stored at the direction of the device at the storage location (and is marked for deletion). The empty trash affordance 533 is displayed concurrently with descriptive text 535C that provides a description of the empty trash operation.

In some embodiments, the description of the first data storage management operation includes (630) information regarding an amount of storage at the storage location freed by the first data storage management operation. Providing information regarding an amount of storage freed by the first data storage management operation provides feedback to the user as to an amount of improvement of the performance of the device as a result of performing the first data storage management operations, thus increasing the likelihood that more beneficial data storage management operations will be performed. For example, in FIG. 5D, the descriptive text 535C includes information regarding an amount of storage at the storage location freed by the empty trash operation (e.g., 1.7 GB).

The plurality of data storage management operations includes (632) a second data storage management affordance that is associated with a second data storage management operation that is configured to be performed on data stored at the direction of the device at the storage location and is displayed concurrently with a description of the second data storage management operation. For example, in FIG. 5D, the data storage management user interface 530 includes a cloud photo storage affordance 533B that is associated with a cloud photo storage operation that is performed on data stored at the direction of the device at the storage location. The cloud photo storage affordance 533C is displayed concurrently with descriptive text 535B that provides a description of the cloud photo storage operation.

In some embodiments, the plurality of data storage management operations corresponds (634) to data associated with an active user (e.g., a logged-in user). In some embodiments, the data storage management user interface includes (636) an indication of an amount of data stored at the storage location associated other users who are not the currently active user. For example, in FIG. 5D, the data storage management user interface 530 includes an other users view affordance 534F displayed in association with an indication of an amount of data stored at the storage location associated with other users who are not the currently active user. In some embodiments, the plurality of data storage management operations corresponds (638) to data associated with multiple users.

In some embodiments, the data storage management user interface includes (640) a first region including the plurality of data storage management affordances and a second region including a plurality of view affordances, wherein each of the plurality of view affordances is selectable to display a respective storage management user interface. For example, in FIG. 5D, the data storage management user interface 530 includes a first region 531 including a plurality of data storage management affordances 533A-533D and a second region 532 including a plurality of view affordances 534A-534G which are selectable to display respective storage management user interfaces (as illustrated, for example, in FIG. 5K and FIG. 5J).

While displaying the data storage management user interface, the device detects (642), via the input device, selection of a particular data storage management affordance of the plurality of data storage management affordances. For example, in FIG. 5D, the device detects selection of the delete cached mail affordance 533A. As another example, in FIG. 5F, the device detects selection of the empty trash affordance 533C.

In response to detecting selection of the particular data storage management affordance, and in accordance with a determination that the particular data storage management affordance is the first data storage management affordance, the device initiates (644) a process for performing the first data storage management operation. For example, in FIG. 5E, in response to detecting selection of the delete cached mail affordance 533A, the device initiates a process for performing the delete cached mail affordance by displaying the confirmation user interface 551A.

In response to detecting selection of the particular data storage management affordance, and in accordance with a determination that the particular data storage management affordance is the second data storage management affordance, the device initiates (646) a process for performing the second data storage management operation. For example, in FIG. 5G, in response to detecting selection of the empty trash affordance 533C, the device initiates a process for performing the empty trash operation by automatically performing the empty trash operation.

In some embodiments, in response to initiating a process to perform of one of the data storage management operations, the device displays (848), on the display, an option to automatically perform periodic data storage management operations that correspond to the one of the data storage management operations that, if selected, causes the device to periodically perform the one of the data storage management operations. Providing an option to automatically perform the data storage management operations increases the likelihood that such data storage management operations will be performed and continually improves the performance of the device by more efficiently managing data stored at the location of the storage device. For example, in FIG. 5E, in response to initiating a process to perform the delete cached mail operation, the device displays the auto-repeat affordance 551D which, if selected, causes the device to periodically perform a delete cached mail operation.

In some embodiments, the device detects (650), via the input device, an applications view input selecting an applications view affordance of the plurality of view affordances. For example, in FIG. 5I, the device detects a selection of the applications view affordance 534B of the plurality of view affordances 534A-534G in the second section 532 of the data storage management user interface 530.

In some embodiments, in response to detecting the applications view input, the device displays (652), on the display, an applications storage management user interface including a list of applications installed at the storage location displayed in association with an indication of the size of the application and a delete affordance for uninstalling the application. Thus, a user can quickly identify applications that use a large amount of storage at the storage location and just as quickly uninstall them, increasing the amount of free storage at the storage location. For example, in FIG. 5J, in response to detecting selection of the applications view affordance 534B in FIG. 5I, the device displays an applications storage management user interface 542. The applications storage management user interface 542 of FIG. 5J includes a list of applications installed at the storage location displayed in association with an indication of the size 561A of the application and a delete affordance 561D for uninstalling the application.

In some embodiments, the list of applications is (654) sorted by size and the applications storage management user interface further comprises at least one sort affordance to sort the list of applications by name, last-opened date, or installation date. Thus, a user can quickly identify applications that are infrequently used and can be uninstalled, increasing the amount of free storage at the storage location. For example, in FIG. 5J, the list of applications in the application storage management user interface 542 is sorted, by default, by size and the application storage management user interface 542 includes sort affordances 562A-562C for sorting by size, last-opened date, and name.

In some embodiments, the device detects (656), via the input device, a media view input selecting a media view affordance of the plurality of view affordances. For example, in FIG. 5J, the device detects a selection of the media view affordance 534C of the plurality of view affordances 534A-534G in the second section 532 of the data storage management user interface 530.

In some embodiments, in response to detecting the media via input, the device displays (658), on the display, a media storage management user interface including a list of media items stored at the storage location in association with an indication of the size of the media item and a delete affordance for deleting the media item. Thus, a user can quickly identify media items that use a large amount of storage at the storage location and just as quickly delete them, increasing the amount of free storage at the storage location. For example, in FIG. 5K, in response to detecting selection of the media view affordance 534C in FIG. 5J, the device displays a media storage management user interface 543. The media storage management user interface 543 of FIG. 5K includes a list of media items stored at the storage location displayed in association with an indication of the size 563A of the media item and a delete affordance 563E for deleting the media item.

In some embodiments, the list of media items includes (660) visually separated sub-lists of media items of particular media types. For example, in FIG. 5K, the media storage management user interface 543 includes visually separated sub-lists of movies and television shows. In some embodiments, the list of media files is displayed (662) in association with a consumption indicator indicative of a consumption level of the media file. Thus, a user can quickly identify media items (such as movies, television shows, podcasts, or audiobooks) that have been consumed and are unlikely to be consumed again and delete them, increasing the amount of free storage at the storage location. Further, a user can quickly identify media items (such as songs or albums) that are infrequently consumed and delete them, increasing the amount of free storage at the storage location. For example, in FIG. 5K, the list of media items is displayed in association with a consumption indicator 563D indicative of an amount of the media item has been consumed.

In some embodiments, the device detects (664), via the input device, a documents view input selecting a documents view affordance of the plurality of view affordances. For example, in FIG. 5K, the device detects a selection of the documents view affordance 534D of the plurality of view affordances 534A-534G in the second section 532 of the data storage management user interface 530.

In some embodiments, in response to detecting the documents view input, the device displays (666), on the display, a documents storage management user interface including a list of document items stored at the storage location in association with an indication of the size of the document item and a delete affordance for deleting the document item. For example, in FIG. 5L, in response to detecting selection of the document view affordance 534D in FIG. 5K, the device displays a document storage management user interface 544. The media storage management user interface 544 of FIG. 5L includes a list of document items stored at the storage location displayed in association with an indication of the size 565A of the document item and a delete affordance 565E for deleting the document item.

In some embodiments, the list of document items includes (668) document items stored at the storage location having a size greater than a threshold. For example, in FIG. 5L, each of document items has a size greater than 0.25 GB. In some embodiments, the list of document items excludes (670) items that are visible in other storage management user interfaces of the data storage management user interface. By excluding items that are visible in other storage management user interfaces, the document items can be more easily identified by the user for deletion, saving time to manage storage of the document items. For example, in FIG. 5L, the list of document items does not include the installed applications of the applications storage management user interface 542 or the stored media items of the media storage management user interface 543. In some embodiments, the list of document items includes (672) items that are visible in other storage management user interfaces of the data storage management user interface.

In some embodiments, the device detects (674), via the input device, a file view input selecting a file view affordance. For example, in FIG. 5L, the device detects a selection of the view toggle affordance 567 in the first section 532 of the data storage management user interface 530. As another example, the device can detect a selection of the file view affordance 534E of the plurality of view affordances 534A-534G in the second section 532 of the data storage management user interface 530.

In some embodiments, in response to the file view input, the device displays (676), on the display, a navigable file system hierarchy including a list of nodes. For example, in FIG. 5M, in response to detecting selection of the view toggle affordance 567 in FIG. 5L, the device displays a file storage management user interface 545. The file storage management user interface 545 of FIG. 5M includes navigable file system hierarchy including a list of nodes. In some embodiments, list of nodes is (678) sorted by size of the node and displayed with an indication of the size of the node and a delete affordance to delete the node. . Thus, a user can quickly identify nodes that use a large amount of storage at the storage location and just as quickly delete them, increasing the amount of free storage at the storage location. For example, the file storage management user interface 545 of FIG. 5M includes a list of nodes sorted by the size of the node and displayed with an indication of the size 568A of the node and a delete affordance 568C to delete the node. In some embodiments, at least one node of the list of nodes is (680) expandable to display sub-nodes sorted by size of the sub-node and displayed with an indication of the size of the sub-node and a delete affordance to delete the sub-node. For example, in FIG. 5N, the navigable file system hierarchy includes a node expanded to display a list of sub-nodes sorted by size of the sub-node and displayed with an indication of the size 568D of the sub-node and a delete affordance 568F to delete the sub-node.

It should be understood that the particular order in which the operations in FIGS. 6A-6E have been described is merely example and is not intended to indicate that the described order is the only order in which the operations could be performed. One of ordinary skill in the art would recognize various ways to reorder the operations described herein.

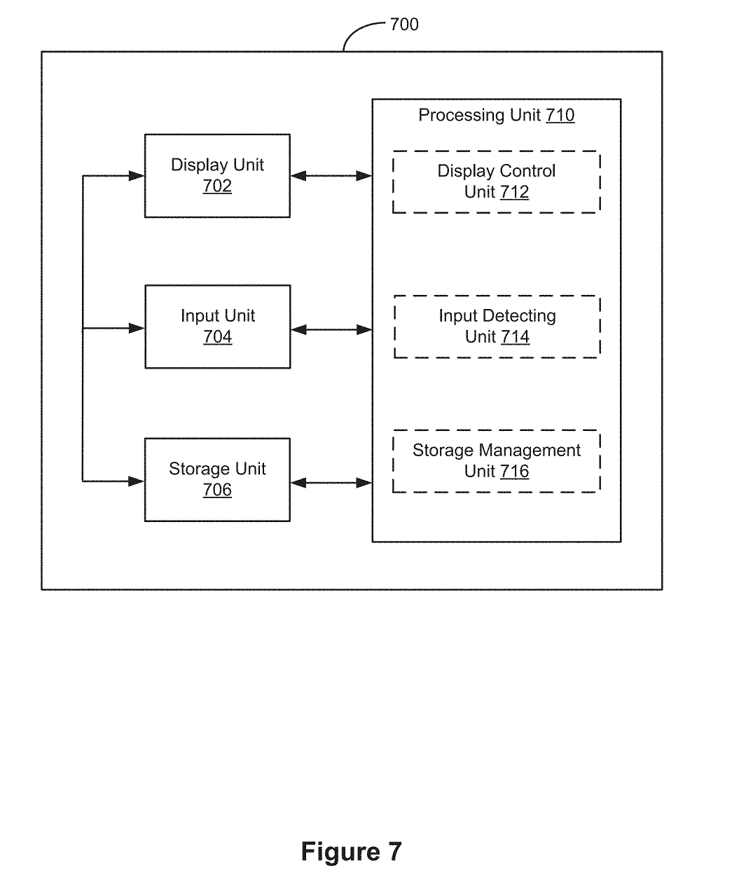

In accordance with some embodiments, FIG. 7 shows a functional block diagram of an electronic device 700 configured in accordance with the principles of the various described embodiments. The functional blocks of the device are, optionally, implemented by hardware, software, firmware, or a combination thereof to carry out the principles of the various described embodiments. It is understood by persons of skill in the art that the functional blocks described in FIG. 7 are, optionally, combined or separated into sub-blocks to implement the principles of the various described embodiments. Therefore, the description herein optionally supports any possible combination or separation or further definition of the functional blocks described herein.

As shown in FIG. 7, an electronic device 700 includes a display unit 702 configured to display a user interface, an input unit 704 configured to generate one or more inputs, a storage unit configured to store data and having a limited available storage capacity, and a processing unit 710 coupled with the display unit 702, the input unit 704, and the storage unit 706. In some embodiments, the processing unit 710 includes a display control unit 712, an input detecting unit 714, and a storage management unit 716.

The processing unit 710 is configured to detect (e.g., with the input detecting unit 714), via the input unit 704, a management input indicative of a request to manage data stored at the direction of the device on the storage unit 706. In some embodiments, the processing unit 710 is configured to display (e.g., with the display control unit 712), on the display unit 702, a storage usage user interface including information regarding usage of storage of the storage unit 706, wherein the management input corresponds to selection of a management affordance displayed in the storage usage user interface. In some embodiments, the information regarding usage of storage of the storage unit 706 includes a graphical representation of the usage of storage of the storage unit 706. In some embodiments, the information regarding usage of storage of the storage unit 706 includes a warning notification indicating that an amount of data stored on the storage unit 706 meets warning criteria. In some embodiments, the warning criteria includes a criterion that is met when the amount of data stored on the storage unit 706 exceeds a threshold. In some embodiments, the warning criteria includes a criterion that is met when the amount of data stored on the storage unit 706 provides unused storage of the storage unit 706 that is insufficient to perform an operation requested by a user.

The processing unit 710 is configured to display (e.g., with the display control unit 712), on the display unit 702, a data storage management user interface that includes a plurality of data storage management affordances respectively associated with a plurality of data storage management operations. In some embodiments, at least one of plurality of data storage management affordances is selectable to initiate a respective data storage management operation. In some embodiments, at least one of the plurality of data storage management affordances is selectable to display a confirmation affordance which is selectable to initiate a respective data storage management operation.

In some embodiments, the plurality of data storage management operations includes one or more data storage management operations that immediately free an amount of storage of the storage unit 706. In some embodiments, the one or more data storage management operations that immediately free an amount of storage of the storage unit 706 includes one or more of an operation that permanently deletes items that have been marked for deletion, an operation that deletes one or more applications, an operation that deletes a cache of one or more applications, or an operation that removes media that meets predefined criteria.

In some embodiments, the plurality of data storage management operations includes one or more data storage management operations that enable a reduction of data stored on the storage unit 706. In some embodiments, the one or more data storage management operations that enable a reduction of data stored on the storage unit 706 includes an operation that stores data stored on the storage unit 706 at a remote storage location or an operation to allow deletion of media items while maintaining at least a threshold amount of media items.

The plurality of data storage management operations includes a first data storage management affordance that is associated with a first data storage management operation that is configured to be performed on data stored at the direction of the device on the storage unit and is displayed concurrently with a description of the first data storage management operation. In some embodiments, the description of the first data storage management operation includes information regarding an amount of storage of the storage unit freed by the first data storage management operation. The plurality of data storage management operations includes a second data storage management affordance that is associated with a second data storage management operation that is configured to be performed on data stored at the direction of the device on the storage unit 706 and is displayed concurrently with a description of the second data storage management operation.

In some embodiments, the plurality of data storage management operations correspond to data associated with an active user. In some embodiments, the data storage management user interface includes an indication of an amount of data stored on the storage unit 706 associated other users who are not the currently active user. In some embodiments, the plurality of data storage management operations correspond to data associated with multiple users.

In some embodiments, the data storage management user interface includes a first region including the plurality of data storage management affordances and a second region including a plurality of view affordances, wherein each of the plurality of view affordances is selectable to display a respective storage management user interface.

While displaying the data storage management user interface, the processing unit 710 is configured to detect (e.g., with the input detecting unit 714), via the input unit 704, selection of a particular data storage management affordance of the plurality of data storage management affordances.

In response to detecting selection of a particular data storage management affordance and in accordance with a determination that the particular data storage management affordance is the first data storage management affordance, the processing unit 710 is configured to initiate (e.g., with the storage management unit 716) a process for performing the first data storage management operation. In response to detecting selection of a particular data storage management affordance and in accordance with a determination that the particular data storage management affordance is the second data storage management affordance, the processing unit 710 is configured to initiate (e.g., with the storage management unit 716) a process for performing the second data storage management operation.

In some embodiments, in response to initiating performance of a data storage management operation, the processing device 710 is configured to display (e.g., with the display control unit 712), on the display unit 702, an option to automatically perform periodic data storage management operations that correspond to the one of the data storage management operations that, if selected, causes the processing unit 710 to periodically perform the one of the data storage management operations.

In some embodiments, the processing unit 710 detects (e.g., with the input detecting unit 714), via the input unit 704, an applications view input selecting an applications view affordance of the plurality of view affordances. In some embodiments, in response to detecting the applications view input, the processing unit 710 is configured to display (e.g., with the display control unit 712), on the display unit 702, an applications storage management user interface including a list of applications installed on the storage unit 706 displayed in association with an indication of the size of the application and a delete affordance for uninstalling the application. In some embodiments, the list of applications is sorted by size and the applications storage management user interface further comprises at least one sort affordance to sort the list of applications by name, last-opened date, or installation date.

In some embodiments, the processing unit 710 detects (e.g., with the input detecting unit 714), via the input unit 704, a media view input selecting a media view affordance of the plurality of view affordances. In some embodiments, in response to detecting the media view input, the processing unit 710 is configured to display (e.g., with the display control unit 712), on the display unit 702, a media storage management user interface including a list of media items stored on the storage unit 706 in association with an indication of the size of the media item and a delete affordance for deleting the media item. In some embodiments, the list of media items includes visually separated sub-lists of media items of particular media types. In some embodiments, the list of media files is displayed in association with a consumption indicator indicative of a consumption level of the media file

In some embodiments, the processing unit 710 detects (e.g., with the input detecting unit 714), via the input unit 704, a documents view input selecting a documents view affordance of the plurality of view affordances. In some embodiments, in response to detecting the documents view input, the processing unit 710 is configured to display (e.g., with the display control unit 712), on the display unit 702, a documents storage management user interface including a list of document items stored on the storage unit 706 in association with an indication of the size of the document item and a delete affordance for deleting the document item. In some embodiments, the list of document items includes document items stored on the storage unit 706 having a size greater than a threshold. In some embodiments, the list of document items excludes items that are visible in other storage management user interfaces of the data storage management user interface. In some embodiments, the list of document items includes items that are visible in other storage management user interfaces of the data storage management user interface.

In some embodiments, the processing unit 710 detects (e.g., with the input detecting unit 714), via the input unit 704, a file view input selecting a file view affordance. In some embodiments, in response to detecting the file view input, the processing unit 710 is configured to display (e.g., with the display control unit 712), on the display unit 702, a navigable file system hierarchy including a list of nodes. In some embodiments, the list of nodes is sorted by size of the node and displayed with an indication of the size of the node and a delete affordance to delete the node. In some embodiments, at least one node of the list of nodes is expandable to display sub-nodes sorted by size of the sub-node and displayed with an indication of the size of the sub-node and a delete affordance to delete the sub-node.

The operations in the information processing methods described above are, optionally implemented by running one or more functional modules in information processing apparatus such as general purpose processors (e.g., as described above with respect to FIGS. 1A and 3) or application specific chips.

The operations described above with reference to FIGS. 6A-6E are, optionally, implemented by components depicted in FIGS. 1A-1B or FIG. 7. For example, detecting operation 602, displaying operation 614, detecting operation 642, initiating operation 644, and initiating operation 646 are, optionally, implemented by event sorter 170, event recognizer 180, and event handler 190. Event monitor 171 in event sorter 170 detects a contact on touch-sensitive display 112, and event dispatcher module 174 delivers the event information to application 136-1. A respective event recognizer 180 of application 136-1 compares the event information to respective event definitions 186, and determines whether a first contact at a first location on the touch-sensitive surface (or whether rotation of the device) corresponds to a predefined event or sub-event, such as selection of an object on a user interface, or rotation of the device from one orientation to another. When a respective predefined event or sub-event is detected, event recognizer 180 activates an event handler 190 associated with the detection of the event or sub-event. Event handler 190 optionally uses or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

What is claimed is:

1. A method comprising:
at a device with one or more processors, non-transitory memory, a display, and an input device:
detecting, via the input device, a management input indicative of a request to manage data stored at the direction of the device at a storage location with a limited available storage capacity; and
in response to detecting the management input, displaying, on the display, a data storage management user interface that includes a plurality of data storage management affordances respectively associated with a plurality of data storage management operations, wherein the plurality of data storage management affordances include:
a first data storage management affordance that is associated with a first data storage management operation that is configured to be performed on data stored at the direction of the device at the storage location and is displayed concurrently with a description of the first data storage management operation; and
a second data storage management affordance that is associated with a second data storage management operation that is configured to be performed on data stored at the direction of the device at the storage location and is displayed concurrently with a description of the second data storage management operation;
while displaying the data storage management user interface, detecting, via the input device, selection of a particular data storage management affordance of the plurality of data storage management affordances; and
in response to detecting selection of the particular data storage management affordance:
in accordance with a determination that the particular data storage management affordance is the first data storage management affordance, initiating a process for performing the first data storage management operation; and
in accordance with a determination that the particular data storage management affordance is the second data storage management affordance, initiating a process for performing the second data storage management operation.

2. The method of claim 1, wherein the description of the first data storage management operation includes information regarding an amount of storage at the storage location freed by the first data storage management operation.

3. The method of claim 1, wherein the plurality of data storage management operations includes one or more data storage management operations that immediately free an amount of storage at the storage location.

4. The method of claim 3, wherein the one or more data storage management operations that immediately free an amount of storage at the storage location includes one or more of an operation that permanently deletes items that have been marked for deletion, an operation that deletes one or more applications, an operation that deletes a cache of one or more applications, or an operation that removes media that meets predefined criteria.

5. The method of claim 1, wherein the plurality of data storage management operations includes one or more data storage management operations that enable a reduction of data stored at the storage location.

6. The method of claim 5, wherein the one or more data storage management operations that enable a reduction of data stored at the storage location includes an operation that stores data stored at the storage location at a remote storage location, or an operation to allow deletion of media items while maintaining at least a threshold amount of media items.

7. The method of claim 1, wherein at least one of plurality of data storage management affordances is selectable to initiate a respective data storage management operation.

8. The method of claim 1, wherein at least one of the plurality of data storage management affordances is selectable to display a confirmation affordance which is selectable to initiate a respective data storage management operation.

9. The method of claim 1, further comprising, in response to initiating a process to perform of one of the data storage management operations, displaying, on the display, an option to automatically perform periodic data storage management operations that correspond to the one of the data storage management operations that, if selected, causes the device to periodically perform the one of the data storage management operations.

10. The method of claim 1, further comprising displaying, on the display, a storage usage user interface including information regarding usage of storage at the storage location, wherein the management input corresponds to selection of a management affordance displayed in the storage usage user interface.

11. The method of claim 10, wherein the information regarding usage of storage at the storage location includes a graphical representation of the usage of storage at the storage location.

12. The method of claim 10, wherein the information regarding usage of storage at the storage location includes a warning notification indicating that an amount of data stored at the storage location meets warning criteria.

13. The method of claim 12, wherein the warning criteria includes a criterion that is met when the amount of data stored at the storage location exceeds a threshold.

14. The method of claim 12, wherein the warning criteria includes a criterion that is met when the amount of data stored at the storage location provided unused storage at the storage location that is insufficient to perform an operation requested by a user.

15. The method of claim 1, wherein the data storage management user interface includes a first region including the plurality of data storage management affordances and a second region including a plurality of view affordances, wherein each of the plurality of view affordances is selectable to display a respective storage management user interface.

16. The method of claim 15, further comprising:
detecting, via the input device, an applications view input selecting an applications view affordance of the plurality of view affordances; and
in response to detecting the applications view input, displaying, on the display, an applications storage management user interface including a list of applications installed at the storage location displayed in association with an indication of the size of the application and a delete affordance for uninstalling the application.

17. The method of claim 16, wherein the list of applications is sorted by size and the applications storage management user interface further comprises at least one sort affordance to sort the list of applications by name, last-opened date, or installation date.

18. The method of claim 1, further comprising:
detecting, via the input device, a media view input selecting a media view affordance of the plurality of view affordances; and
in response to detecting the media view input, displaying, on the display, a media storage management user interface including a list of media items stored at the storage location in association with an indication of the size of the media item and a delete affordance for deleting the media item.

19. The method of claim 18, wherein the list of media items includes visually separated sub-lists of media items of particular media types.

20. The method of claim 18, the list of media files is displayed in association with a consumption indicator indicative of a consumption level of the media file.

21. The method of claim 15, further comprising:
detecting, via the input device, a documents view input selecting a documents view affordance of the plurality of view affordances; and
in response to the document view input, displaying, on the display, a documents storage management user interface including a list of document items stored at the storage location in association with an indication of the size of the document item and a delete affordance for deleting the document item.

22. The method of claim 21, wherein the list of document items includes document items stored at the storage location having a size greater than a threshold.

23. The method of claim 21, wherein the list of document items excludes items that are visible in other storage management user interfaces of the data storage management user interface.

24. The method of claim 21, wherein the list of document items includes items that are visible in other storage management user interfaces of the data storage management user interface.

25. The method of claim 15, further comprising:
detecting, via the input device, a file view input selecting a file view affordance; and
in response to detecting the file view input, displaying, on the display, a navigable file system hierarchy including a list of nodes.

26. The method of claim 25, wherein the list of nodes is sorted by size of the node and displayed with an indication of the size of the node and a delete affordance to delete the node.

27. The method of claim 25, wherein at least one node of the list of nodes is expandable to display sub-nodes sorted by size of the sub-node and displayed with an indication of the size of the sub-node and a delete affordance to delete the sub-node.

28. The method of claim 1, wherein the plurality of data storage management operations correspond to data associated with an active user.

29. A non-transitory computer readable storage medium storing one or more programs, the one or more programs comprising instructions, which, when executed by an electronic device with a display, and an input device, cause the electronic device to:
detect, via the input device, a management input indicative of a request to manage data stored at the direction of the device at a storage location with a limited available storage capacity; and
in response to detecting the management input, display, on the display, a data storage management user interface that includes a plurality of data storage management affordances respectively associated with a plurality of data storage management operations, wherein the plurality of data storage management affordances include:
a first data storage management affordance that is associated with a first data storage management operation that is configured to be performed on data stored at the direction of the device at the storage location and is displayed concurrently with a description of the first data storage management operation; and
a second data storage management affordance that is associated with a second data storage management operation that is configured to be performed on data stored at the direction of the device at the storage location and is displayed concurrently with a description of the second data storage management operation;
while displaying the data storage management user interface, detect, via the input device, selection of a particular data storage management affordance of the plurality of data storage management affordances; and
in response to detecting selection of the particular data storage management affordance:
in accordance with a determination that the particular data storage management affordance is the first data storage management affordance, initiate a process for performing the first data storage management operation; and
in accordance with a determination that the particular data storage management affordance is the second data storage management affordance, initiate a process for performing the second data storage management operation.

30. An electronic device, comprising:
a display unit configured to display a user interface;
one or more input units configured to receive inputs;
a storage unit configured to store data and having a limited available storage capacity; and
a processing unit coupled with the display unit, the one or more input units, and the storage unit, the processing unit configured to:
detect, via the one or more input units, a management input indicative of a request to manage data stored on the storage unit; and
in response to detecting the management input, display, on the display unit, a data storage management user interface that includes a plurality of data storage management affordances respectively associated with a plurality of data storage management operations, wherein the plurality of data storage management affordances include:
a first data storage management affordance that is associated with a first data storage management operation that is configured to be performed on data stored on the storage unit and is displayed concurrently with a description of the first data storage management operation; and
a second data storage management affordance that is associated with a second data storage management operation that is configured to be performed on data stored on the storage unit and is displayed concurrently with a description of the second data storage management operation;
while displaying the data storage management user interface, detect, via the one or more input units, selection of a particular data storage management affordance of the plurality of data storage management affordances; and
in response to detecting selection of the particular data storage management affordance:
in accordance with a determination that the particular data storage management affordance is the first data storage management affordance, initiate a process for performing the first data storage management operation; and
in accordance with a determination that the particular data storage management affordance is the second data storage management affordance, initiate a process for performing the second data storage management operation.
